(19) United States
(12) Patent Application Publication
(10) Pub. No.: US 2026/0339108 A1
(43) Pub. Date: Oct. 29, 2026

(54) CAMERA MODULE AND WEARABLE ELECTRONIC DEVICE INCLUDING THE SAME

(71) Applicant: SAMSUNG ELECTRONICS CO., LTD., Suwon-si (KR)

(72) Inventors: Yeonggyu YOON, Suwon-si (KR); Sangsung WOO, Suwon-si (KR); Sungjin YUM, Suwon-si (KR); Joohyung KIM, Suwon-si (KR); Minsoo KIM, Suwon-si (KR); Jihye KWON, Suwon-si (KR)

(21) Appl. No.: 19/559,772

(22) Filed: Mar. 6, 2026

Related U.S. Application Data
(63) Continuation of application No. PCT/KR2026/002760, filed on Feb. 13, 2026.

(30) Foreign Application Priority Data
Apr. 28, 2025 (KR) 10-2025-0055563
May 19, 2025 (KR) 10-2025-0064828

(51) Int. Cl. G02B 27/01; G02C 5/22; G02C 11/00; G03B 30/00

(52) U.S. Cl. CPC G02B 27/0176; G02B 27/0172; G02C 5/2236; G02C 11/10; G03B 30/00; G02B 2027/0134; G02B 2027/0138; G02B 2027/0178

(57) ABSTRACT

A wearable electronic device according to an embodiment may include a rim having an opening formed toward a front side, a temple disposed on one side of the rim, a hinge structure rotatably connecting the temple to the rim, and a camera module disposed at least partially movable within the rim or the hinge structure. The camera module may include a camera, and a camera bracket including a space for receiving the camera and a pole connected to the hinge structure. The hinge structure may include a guide slot forming a movement path of the pole with a portion of the pole inserted therein. When the temple rotates with respect to the rim, the pole of the camera bracket may move along the guide slot, and the camera received in the camera bracket may be configured to move toward the front side or a rear side.

### CROSS-REFERENCE TO RELATED APPLICATIONS

This application is a continuation application of International Application No. PCT/KR2026/002760 designating the United States, filed on Feb. 13, 2026, in the Korean Intellectual Property Receiving Office, which claims priority from Korean Patent Application Nos. 10-2025-0064828, filed on May 19, 2025 and 10-2025-0055563, filed on Apr. 28, 2025, in the Korean Intellectual Property Office, the disclosures of which are hereby incorporated by reference herein in their entireties.

### TECHNICAL FIELD

An embodiment disclosed in the disclosure relates to a camera module configured to be movable (e.g., portable) and a wearable electronic device including the same.

### BACKGROUND ART

Portable electronic devices, such as electronic schedulers, portable multimedia players, mobile communication terminals, or tablet PCs, are generally equipped with a display member and a battery, and come in bar, clamshell, or slidable shape by the shape of the display member or battery. As portable electronic devices, including display members and batteries, are being made smaller with enhanced performance, wearable electronic devices which may be worn on the user's wrist, head, or other body portions are being made commercially available. Wearable electronic devices may be directly worn on the human body, providing better portability and user accessibility.

Among wearable electronic devices, some electronic devices, e.g., head-mounted devices (HMDs), may be worn on the user's head/face. The HMD may be used to implement virtual reality (VR) or augmented reality (AR). For example, the wearable electronic device may stereoscopically provide the image of the virtual space in the game played on TV or computer monitor and may implement VR by blocking the real-world image. Another type of wearable electronic device may be provided in a glasses form (e.g., AR glasses). A glasses-type wearable electronic device may provide AR that implements virtual images and provides various visual information to a user while providing an environment in which a user may visually perceive an actual image of a space where the user is present.

The above-described information may be provided as related art for the purpose of helping understanding of the disclosure. No claim or determination is made as to whether any of the foregoing is applicable as background art in relation to the disclosure.

### DISCLOSURE OF INVENTION

### Solution to Problems

A wearable electronic device according to an embodiment of the disclosure may include a rim having an opening formed toward a front side, a temple disposed on one side of the rim, a hinge structure rotatably connecting the temple to the rim, and a camera module disposed at least partially movable within the rim or the hinge structure. The camera module may include a camera, and a camera bracket including a space for receiving the camera and a pole connected to the hinge structure. The hinge structure may include a guide slot forming a movement path of the pole with a portion of the pole inserted therein. When the temple rotates with respect to the rim, the pole of the camera bracket may move along the guide slot, and the camera received in the camera bracket may be configured to move toward the front side or a rear side.

A wearable electronic device according to an embodiment of the disclosure may include a rim having an opening formed toward a front side, a temple disposed on one side of the rim, a hinge structure rotatably connecting the temple to the rim, a camera module disposed at least partially movable within the rim or the hinge structure, at least one processor including processing circuitry, and a memory storing one or more instructions. The instructions may, when executed by the at least one processor individually or collectively, cause the wearable electronic device to, in the unfolded state of the temple with respect to the rim, when a portion of the camera module is exposed to the outside, activate power to the camera module to control the camera module to be in a state capable of capturing images, and in the folded state of the temple with respect to the rim, when the camera module is received inside the rim, deactivate power to the camera module to control the camera module to be in a state incapable of capturing images.

However, the problems to be solved by the disclosure are not limited to those mentioned above and may be variously extended without departing from the spirit and scope of the disclosure.

### BRIEF DESCRIPTION OF DRAWINGS

FIG. 1 is a block diagram illustrating an electronic device in a network environment according to an embodiment of the disclosure.

FIG. 2 illustrates an example of a perspective view illustrating a wearable device according to an embodiment of the disclosure.

FIG. 3 illustrates an example of one or more hardware components disposed within a wearable device according to an embodiment of the disclosure.

FIG. 4 is an exploded perspective view illustrating a camera module and a hinge structure of a wearable electronic device according to an embodiment of the disclosure.

FIG. 5A is a view illustrating an upper surface and a side surface of a wearable electronic device in a folded state of the wearable electronic device according to an embodiment of the disclosure.

FIG. 5B is a cross-sectional view taken along a direction A-A′ from the side surface of FIG. 5A according to an embodiment of the disclosure.

FIG. 6A is a view illustrating an upper surface and a side surface of a wearable electronic device in an unfolded state of the wearable electronic device according to an embodiment of the disclosure.

FIG. 6B is a cross-sectional view taken along a direction B-B′ from the side surface of FIG. 6A according to an embodiment of the disclosure.

FIG. 7 is a perspective view illustrating a camera module located within a hinge structure of a wearable electronic device according to an embodiment of the disclosure.

FIG. 8 is a view illustrating a camera module viewed from an upper side according to an embodiment of the disclosure.

FIG. 9 is a projection view illustrating a connection structure between a guide slot and a pole in an unfolded state of a wearable electronic device according to an embodiment of the disclosure.

FIG. 10 is a view illustrating a hinge structure viewed toward a rear lateral direction in an unfolded state of a wearable electronic device according to an embodiment of the disclosure.

FIG. 11 is a cross-sectional view taken along a direction C-C′ of FIG. 10 in an unfolded state of a wearable electronic device according to an embodiment of the disclosure.

FIG. 12 is a cross-sectional view taken along a direction C-C′ of FIG. 10 in a folded state of a wearable electronic device according to an embodiment of the disclosure.

FIG. 13 is a view illustrating a distance between a magnet and a sensor in a folded state of a wearable electronic device according to an embodiment of the disclosure.

FIG. 14 is a view illustrating a distance between a magnet and a sensor in an unfolded state of a wearable electronic device according to an embodiment of the disclosure.

FIG. 15A is a flowchart illustrating a method of operating a camera of a wearable electronic device configured to assume a folded state unsuitable for being worn by a user, an unfolded state suitable for being worn by the user and an intermediate state between the folded and unfolded states according to a embodiment of the disclosure.

FIG. 15B is a flowchart illustrating an example operation of a camera module for an unfolding/folding operation of a wearable electronic device according to an embodiment of the disclosure.

FIG. 16 is a view illustrating a state in which a camera module is covered in a folded state of a wearable electronic device according to an embodiment of the disclosure.

FIG. 17 is a view illustrating a state in which a camera module is uncovered in an unfolded state of a wearable electronic device according to an embodiment of the disclosure.

FIG. 18 is a perspective view illustrating an arrangement relationship between a camera and a cover in a folded state of a wearable electronic device according to an embodiment of the disclosure.

FIG. 19 is a cross-sectional view illustrating an arrangement relationship between a camera and a cover in a folded state of a wearable electronic device according to an embodiment of the disclosure.

FIG. 20 is a perspective view illustrating a cover structure of a camera module according to an embodiment of the disclosure.

FIG. 21 is a view for illustrating a relationship between a camera and a cover structure in a folded state of a wearable electronic device according to an embodiment of the disclosure.

FIG. 22 is a view for illustrating a relationship between a camera and a cover structure in an unfolded state of a wearable electronic device according to an embodiment of the disclosure.

FIG. 23 is a projection view illustrating a movement slot of a rim and a cover structure in a folded state of a wearable electronic device according to an embodiment of the disclosure.

FIG. 24 is a view illustrating a pole moving through movement slots in case of operating from a folded state to an unfolded state of a wearable electronic device according to an embodiment of the disclosure.

Reference may be made to the accompanying drawings in the following description, and specific examples that may be practiced are shown as examples within the drawings. Other examples may be utilized and structural changes may be made without departing from the scope of the various examples.

### MODE FOR THE INVENTION

The electronic device according to embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

An embodiment of the disclosure and terms used therein are not intended to limit the technical features described in the disclosure to specific embodiments, and should be understood to include various modifications, equivalents, or substitutes of the embodiment. In connection to the description of the drawings, similar reference numerals may be used for similar or related components. It is to be understood that a singular form of a noun corresponding to an item may include one or more of the things, unless the relevant context clearly indicates otherwise.

As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

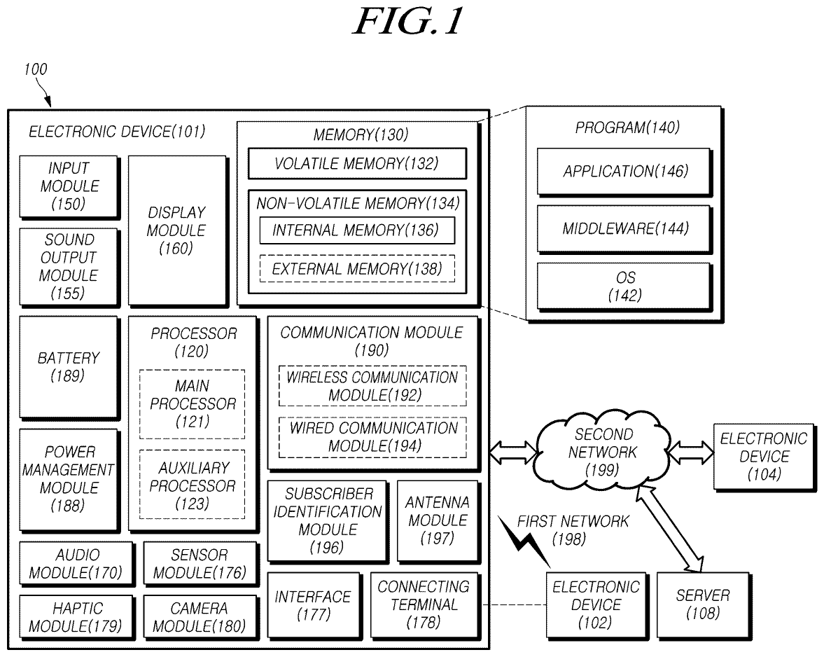

FIG. 1 is a block diagram illustrating an electronic device in a network environment according to an embodiment of the disclosure.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. In an embodiment, some (e.g., the sensor module 176, the camera module 180, or the antenna module 197) of the components may be integrated into a single component (e.g., the display module 160).

The processor 120 may execute, for example, software (e.g., the program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, in case that the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., the electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. The sensor module 176 may include, e.g., a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wiredly) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wiredly) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

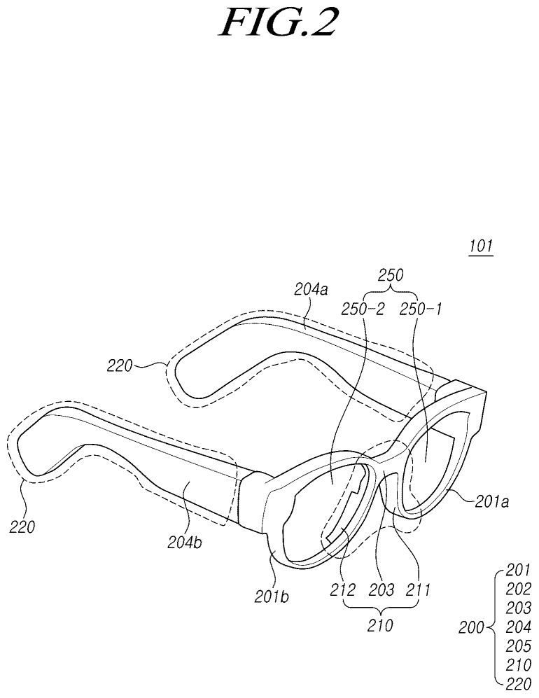

FIG. 2 illustrates an example of a perspective view illustrating a wearable device according to an embodiment of the disclosure.

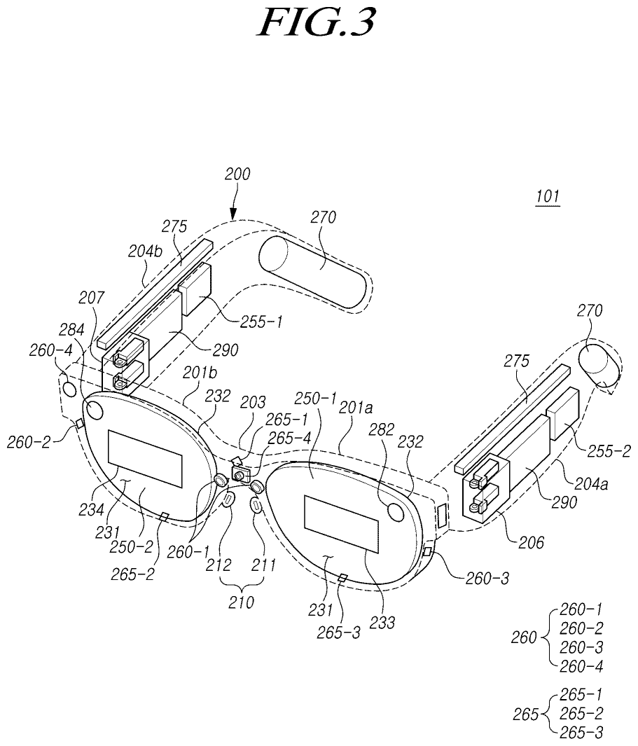

FIG. 3 illustrates an example of one or more hardware components disposed within a wearable device according to an embodiment of the disclosure.

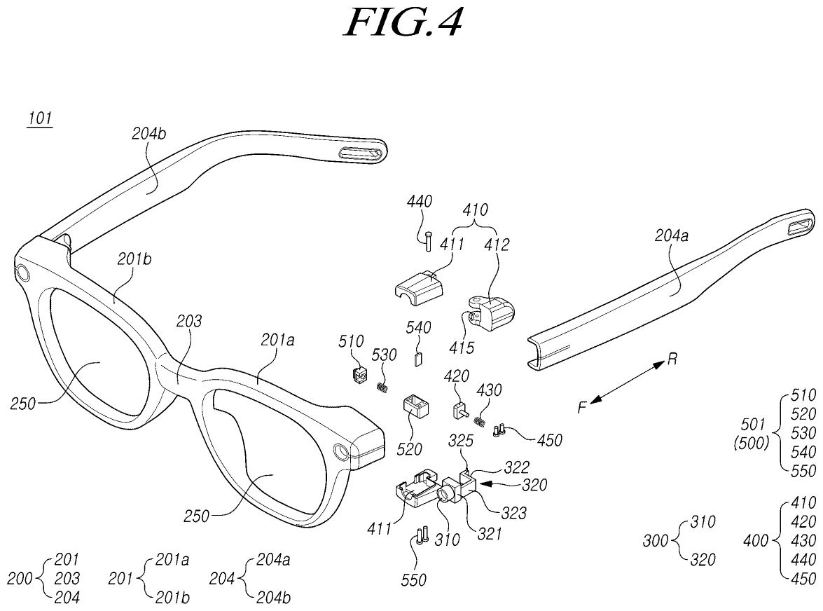

The embodiments of FIGS. 2 and 3 may be combined with the embodiment of FIG. 1 or the embodiments of FIGS. 4 to 24.

The configurations of the embodiments of FIG. 2 and FIG. 3 may be identical in whole or part to the configurations of the embodiment of FIG. 1 and the configurations of the embodiments of FIG. 4 to FIG. 24.

According to an embodiment, a wearable electronic device 101 may have a form of glasses wearable on a body portion (e.g., head) of a user. The wearable electronic device 101 of FIGS. 2 and 3 may be an example of the electronic device 101 of FIG. 1.

According to an embodiment, the wearable electronic device 101 may include a HMD. For example, the housing of the wearable electronic device 101 may include a flexible material, such as rubber and/or silicone, having a form closely contacting a portion of a user's head (e.g., a portion of a face surrounding both eyes). For example, the housing of the wearable electronic device 101 may include one or more straps able to fit around a user's head and/or one or more temples attachable to the ears of the head.

Referring to FIG. 2, a wearable electronic device 101 may include at least one display 250 and a frame 200 supporting the at least one display 250. The display 250 may include one or more displays, such as a first display 250-1 and a second display 250-2.

According to an embodiment, the wearable electronic device 101 may be worn on a portion (or part) of a user's body. The wearable electronic device 101 may provide to a user AR, VR, or mixed reality (MR), which is a combination of AR and VR. For example, the wearable electronic device 101 may display a VR image provided from a first optical device 282 and a second optical device 284, which may be together referred to as optical devices 282, 284 of FIG. 3 on the display 250 in response to a designated gesture (e.g., movement) of a user obtained through the motion recognition camera (or motion tracking camera) 260-2, 260-3 of FIG. 3.

According to an embodiment, the at least one display 250 may provide visual information to a user. For example, the at least one display 250 may include a transparent or translucent lens. The at least one display 250 may include a first display 250-1 and/or a second display 250-2 spaced apart from the first display 250-1. For example, the first display 250-1 and the second display 250-2 may be disposed at positions corresponding to a user's left eye and right eye, respectively.

Referring to FIG. 3, the at least one display 250 may provide visual information delivered to a user from external light through a lens included in the at least one display 250, and other visual information distinguished from the visual information. The lens may be formed based on at least one of a Fresnel lens, a pancake lens, or a multi-channel lens. For example, the at least one display 250 may include a first surface 231 and a second surface 232 opposite to the first surface 231. A display area may be formed on the second surface 232 of the at least one display 250. When a user wears the wearable electronic device 101, external light may be incident on the first surface 231 and transmitted through the second surface 232 to be delivered to the user. For example, the at least one display 250 may display an augmented reality image, in which a virtual reality image provided from the at least one optical device 282, 284 is combined with a real screen delivered through external light, on the display area formed on the second surface 232.

According to an embodiment, the at least one display 250 may include at least one waveguide, including a first waveguide 233 and a second waveguide 234, which may be collectively referred to as the waveguides 233, 234, diffracting light emitted from the optical devices 282, 284 and delivering the light to a user. The waveguides 233, 234 may be formed based on at least one of glass, plastic, or polymer. A nano pattern may be formed on at least a portion of the exterior or interior of the waveguides 233, 234. The nano pattern may be formed based on a grating structure having a polygonal or curved shape. Light incident on one end of the waveguides 233, 234 may be propagated to the other end of the waveguides 233, 234 by the nano pattern. The waveguides 233, 234 may include at least one of at least one diffractive element (e.g., diffractive optical element (DOE), holographic optical element (HOE)) or a reflective element (e.g., a reflective mirror). For example, the waveguides 233, 234 may be disposed in the wearable electronic device 101 to guide a screen displayed by the at least one display 250 to a user's eye. For example, the screen may be transmitted to a user's eye based on total internal reflection (TIR) occurring within the waveguides 233, 234.

According to an embodiment, the wearable electronic device 101 may capture an external space through recording cameras 260-4, 265-4. The wearable electronic device 101 may include one or more recording cameras. The wearable electronic device 101 may analyze an object included in a real image collected through the recording cameras 260-4, 265-4, combine a virtual object corresponding to an object that is a target of AR provision among the analyzed objects, and display the combined image on the at least one display 250. The virtual object may include at least one of text and an image regarding various information related to an object included in the real image. The wearable electronic device 101 may analyze an object based on a multi-camera such as a stereo camera. For the object analysis, the wearable electronic device 101 may perform spatial recognition (e.g., simultaneous localization and mapping (SLAM)) using a multi-camera and/or time-of-flight (ToF). A user wearing the wearable electronic device 101 may view an image displayed on the at least one display 250.

According to an embodiment, the frame 200 may have a physical structure allowing the wearable electronic device 101 to be worn on a user's body. According to an embodiment, the frame 200 may be configured such that the first display 250-1 and the second display 250-2 may be positioned at positions corresponding to a user's left eye and right eye when the user wears the wearable electronic device 101. The frame 200 may support the at least one display 250. For example, the frame 200 may support the first display 250-1 and the second display 250-2 to be positioned at positions corresponding to a user's left eye and right eye.

Referring to FIG. 2, the frame 200 may include an area 220 at least a portion of which contacts a portion of a user's body in case the user wears the wearable electronic device 101. For example, the area 220 of the frame 200 contacting a portion of a user's body may include an area contacting a portion of a user's nose, a portion of a user's ear, and a portion of a side of a user's face that the wearable electronic device 101 contacts. According to an embodiment, the frame 200 may include a nose pad 210 contacting a portion of a user's body. In case the wearable electronic device 101 is worn by a user, the nose pad 210 may contact a portion of the user's nose. The frame 200 may include a first temple 204a and a second temple 204b contacting another portion of the user's body distinguished from the portion of the user's body.

According to an embodiment, the frame 200 may include a first rim 201a surrounding at least a portion of the first display 250-1, a second rim 201b surrounding at least a portion of the second display 250-2, a bridge 203 disposed between the first rim 201a and the second rim 201b, a first pad 211 disposed from one end of the bridge 203 along a portion of an edge of the first rim 201a, a second pad 212 disposed from the other end of the bridge 203 along a portion of an edge of the second rim 201b, a first temple 204a extending from the first rim 201a and fixed to a portion of a wearer's ear, and a second temple 204b extending from the second rim 201b and fixed to a portion of an ear on an opposite side to the ear. The first pad 211 and the second pad 212 may contact a portion of a user's nose, and the first temple 204a and the second temple 204b may contact a portion of a user's face and a portion of an ear. The temples 204a, 204b may be rotatably connected to the rim through the hinge units 206, 207 of FIG. 3. The first temple 204a may be rotatably connected to the first rim 201a through a first hinge unit 206 disposed between the first rim 201a and the first temple 204a. The second temple 204b may be rotatably connected to the second rim 201b through a second hinge unit 207 disposed between the second rim 201b and the second temple 204b. According to an embodiment, the wearable electronic device 101 may identify an external object (e.g., a user's fingertip) touching the frame 200 and/or a gesture performed by the external object using a touch sensor, a grip sensor, and/or a proximity sensor formed on at least a portion of a side (e.g., surface) of the frame 200.

According to an embodiment, the wearable electronic device 101 may include hardware components (e.g., hardware components to be described below based on the block diagram illustrating FIG. 4) performing various functions. For example, the hardware components may include a battery module 270, an antenna module 275, the optical devices 282, 284, speakers (e.g., speakers 255-1, 255-2), a microphone (e.g., microphones 265-1, 265-2, 265-3), a light emitting module (not illustrated), and/or a printed circuit board (PCB) 290. Various hardware components may be disposed within the frame 200.

According to an embodiment, a microphone (e.g., the microphones 265-1, 265-2, 265-3) of the wearable electronic device 101 may be disposed on at least a portion of the frame 200 to obtain a sound signal. Although a first microphone 265-1 disposed on the bridge 203, a second microphone 265-2 disposed on the second rim 201b, and a third microphone 265-3 disposed on the first rim 201a are illustrated in FIG. 2, the number and arrangement of the microphones 265 are not limited to the embodiment of FIG. 2. In case the number of microphones 265 included in the wearable electronic device 101 is two or more, the wearable electronic device 101 may identify a direction of a sound signal using a plurality of microphones disposed on different portions of the frame 200.

According to an embodiment, the optical devices 282, 284 may project a virtual object onto the at least one display 250 to provide various image information to a user. For example, the optical devices 282, 284 may be a projector. The optical devices 282, 284 may be disposed adjacent to the at least one display 250 or may be included in the at least one display 250 as a portion of the at least one display 250. According to an embodiment, the wearable electronic device 101 may include a first optical device 282 corresponding to the first display 250-1 and a second optical device 284 corresponding to the second display 250-2. For example, the optical devices 282, 284 may include a first optical device 282 disposed at an edge of the first display 250-1 and a second optical device 284 disposed at an edge of the second display 250-2. The first optical device 282 may emit light to a first waveguide 233 disposed on the first display 250-1, and the second optical device 284 may emit light to a second waveguide 234 disposed on the second display 250-2.

According to an embodiment, a camera 260 may include recording cameras 260-4, 265-4, an eye tracking camera 260-1, and/or motion recognition cameras 260-2, 260-3. The recording cameras 260-4, 265-4, the eye tracking camera 260-1, and the motion recognition cameras 260-2, 260-3 may be disposed at different positions on the frame 200 and may perform different functions. The eye tracking camera 260-1 may output data indicating a position or gaze of an eye of a user wearing the wearable electronic device 101. For example, the wearable electronic device 101 may detect the gaze from an image including a user's pupil obtained through the eye tracking camera 260-1. The wearable electronic device 101 may identify an object (e.g., a real object and/or a virtual object) focused by a user using a user's gaze obtained through the eye tracking camera 260-1. The wearable electronic device 101 having identified the focused object may execute a function (e.g., gaze interaction) for interaction between the user and the focused object. The wearable electronic device 101 may represent a portion corresponding to an eye of an avatar representing a user in a virtual space using a user's gaze obtained through the eye tracking camera 260-1. The wearable electronic device 101 may render an image (or screen) displayed on the at least one display 250 based on a position of a user's eye. For example, visual quality of a first area related to the gaze and a visual quality (e.g., resolution, brightness, saturation, grayscale, or pixels per inch) of a second area distinguished from the first area in the image may be different from each other. The wearable electronic device 101 may obtain an image (or screen) having a visual quality of the first area matching a user's gaze and a visual quality of the second area using foveated rendering. For example, in case that the wearable electronic device 101 supports an iris recognition function, user authentication may be performed based on iris information obtained using the eye tracking camera 260-1. Although an example in which the eye tracking camera 260-1 is disposed toward both eyes of a user is illustrated in FIG. 2, the embodiment is not limited thereto, and the eye tracking camera 260-1 may be disposed alone toward a user's left eye or right eye.

According to an embodiment, the recording cameras 260-4, 265-4 may capture an actual image or background to be registered with a virtual image to implement AR or mixed reality content. The recording cameras 260-4, 265-4 may be used to obtain a high-resolution image based on high resolution or photo video. The recording cameras 260-4, 265-4 may capture an image of a specific object existing at a position where a user is looking and provide the image to the at least one display 250. The at least one display 250 may display a single image in which information on an actual image or background including the image of the specific object obtained using the recording cameras 260-4, 265-4 and a virtual image provided through the at least one optical devices 282, 284 are overlapped. The wearable electronic device 101 may compensate for depth information (e.g., a distance between the wearable electronic device 101 and an external object obtained through a depth sensor) using an image obtained through the recording cameras 260-4, 265-4. The wearable electronic device 101 may perform object recognition through an image obtained using the recording cameras 260-4, 265-4. The wearable electronic device 101 may perform a function (e.g., auto focus) of focusing on an object (or subject) in an image and/or an optical image stabilization (OIS) function (e.g., hand tremor prevention function) using the recording cameras 260-4, 265-4. The wearable electronic device 101 may perform a pass through function for displaying an image obtained through the recording cameras 260-4, 265-4 overlapped on at least a portion of a screen while displaying a screen representing a virtual space on the at least one display 250. The recording cameras 260-4, 265-4 may be referred to as an high resolution camera or a photo video camera. The recording cameras 260-4, 265-4 may provide an auto focus function and the OIS function. The recording cameras 260-4, 265-4 may include a global shutter (GS) camera and/or a rolling shutter camera. In an embodiment, the recording camera 260-4 may be disposed on one side of the first rim 201a and/or the second rim 201b. In an embodiment, the recording camera 265-4 may be disposed within the bridge 203 between the first rim 201a and the second rim 201b.

According to an embodiment, the eye tracking camera 260-1 may implement more realistic AR by tracking a gaze of a user wearing the wearable electronic device 101 and thereby matching the user's gaze with visual information provided to the at least one display 250. For example, when a user is looking straight ahead, the wearable electronic device 101 may naturally display environmental information related to the front of the user at a place where the user is located on the at least one display 250. The eye tracking camera 260-1 may be configured to capture an image of a user's pupil to determine a user's gaze. For example, the eye tracking camera 260-1 may receive gaze detection light reflected from a user's pupil and track a user's gaze based on a position and movement of the received gaze detection light. In an embodiment, the eye tracking camera 260-1 may be disposed at positions corresponding to a user's left eye and right eye. For example, the eye tracking camera 260-1 may be disposed within the first rim 201a and/or the second rim 201b to face a direction in which a user wearing the wearable electronic device 101 is located.

According to an embodiment, the motion recognition cameras 260-2, 260-3 may provide a specific event to a screen provided on the at least one display 250 by recognizing movement of all or some of a user's body such as a user's torso, hand, or face. The motion recognition cameras 260-2, 260-3 may recognize a user's gesture (gesture recognition), obtain a signal corresponding to the gesture, and provide a display corresponding to the signal to the at least one display 250. A processor may identify the signal corresponding to the gesture and perform a designated function based on the identification. The motion recognition cameras 260-2, 260-3 may be used to perform a spatial recognition function using SLAM and/or a depth map for a six (6) degrees of freedom pose (six DOF pose). The processor may perform a gesture recognition function and/or an object tracking function using the motion recognition cameras 260-2, 260-3. In an embodiment, the motion recognition cameras 260-2, 260-3 may be disposed on the first rim 201a and/or the second rim 201b. The motion recognition cameras 260-2, 260-3 may include the GS camera used for head tracking, hand tracking, and/or spatial recognition based on one of a 3 degrees of freedom pose or a six DOF pose. The GS camera may include two or more stereo cameras to track fine movements. As an example, the GS camera may be included in the eye tracking camera 260-1 for tracking a user's gaze.

According to an embodiment, the camera 260 included in the wearable electronic device 101 is not limited to the above-described eye tracking camera 260-1 and motion recognition cameras 260-2, 260-3. For example, the wearable electronic device 101 may identify an external object included in the field of view (FoV) using a camera disposed toward a user's FoV. Identifying the external object by the wearable electronic device 101 may be performed based on a sensor for identifying a distance between the wearable electronic device 101 and the external object, such as a depth sensor and/or a ToF sensor. The camera 260 disposed toward the FoV may support an autofocus function and/or the OIS function. For example, the wearable electronic device 101 may include a camera 260 (e.g., a face tracking camera) disposed toward the face to obtain an image including the face of a user wearing the wearable electronic device 101.

According to an embodiment, the battery module 270 may supply power to electronic components of the wearable electronic device 101. In an embodiment, the battery module 270 may be disposed within the first temple 204a and/or the second temple 204b. For example, the battery module 270 may be a plurality of battery modules 270. The plurality of battery modules 270 may be disposed in the first temple 204a and the second temple 204b, respectively. In an embodiment, the battery module 270 may be disposed at an end of the first temple 204a and/or the second temple 204b.

According to an embodiment, the antenna module 275 may transmit a signal or power to the outside of the wearable electronic device 101 or receive a signal or power from the outside. In an embodiment, the antenna module 275 may be disposed within the first temple 204a and/or the second temple 204b. For example, the antenna module 275 may be disposed close to one side (e.g., surface) of the first temple 204a and/or the second temple 204b.

According to an embodiment, the speaker 255 may output an acoustic signal to the outside of the wearable electronic device 101. An acoustic output module may be referred to as a speaker. In an embodiment, the speaker 255 may be disposed within the first temple 204a and/or the second temple 204b to be disposed adjacent to an ear of a user wearing the wearable electronic device 101. For example, the speaker 255 may include a second speaker 255-2 disposed adjacent to a user's left ear by being disposed within the first temple 204a, and a first speaker 255-1 disposed adjacent to a user's right ear by being disposed within the second temple 204b.

Throughout the present document, expressions such as “when”, “in case,” “in case of”, “in case that”, or “based on”, which are used to describe temporal, conditional, or causal relationships, may be understood as having substantially the same purport depending on the context and are deemed to be used interchangeably, and are provided merely for convenience of description and not intended to limit the scope of the disclosed embodiments.

Referring to FIG. 3, according to an embodiment, the wearable electronic device 101 may include the PCB 290. The PCB 290 may be included in at least one of the first temple 204a or the second temple 204b. The PCB 290 may include an interposer disposed between at least two sub-PCBs. On the PCB 290, one or more hardware components (e.g., hardware components illustrated by different blocks in FIG. 4) included in the wearable electronic device 101 may be disposed. The wearable electronic device 101 may include a flexible PCB (FPCB) for interconnecting the hardware components.

According to an embodiment, the wearable electronic device 101 may include at least one of a gyro sensor, a gravity sensor, and/or an acceleration sensor for detecting a posture of the wearable electronic device 101 and/or a posture of a body portion (e.g., head) of a user wearing the wearable electronic device 101. Each of the gravity sensor and the acceleration sensor may measure gravitational acceleration and/or acceleration based on designated three-dimensional axes (e.g., an x-axis, a y-axis, and a z-axis) perpendicular to each other. The gyro sensor may measure an angular velocity of each of the designated three-dimensional axes (e.g., an x-axis, a y-axis, and a z-axis). At least one of the gravity sensor, the acceleration sensor, and the gyro sensor may be referred to as an inertial measurement unit (IMU). According to an embodiment, the wearable electronic device 101 may identify a user's motion and/or gesture performed to execute or stop a specific function of the wearable electronic device 101 based on an IMU.

FIG. 4 is an exploded perspective view illustrating a camera module and a hinge structure of a wearable electronic device according to an embodiment of the disclosure.

According to an embodiment, a wearable electronic device 101 may include a frame 200, a display 250, a camera module 300, a hinge structure 400, and/or an embedded module 500. The frame 200 may include a rim 201 (e.g., a first rim 201a, a second rim 201b), a bridge 203 disposed between the first rim 201a and the second rim 201b, and a temple 204 (e.g., a first temple 204a, a second temple 204b). The hinge structure 400 may connect the temple 204 to the rim 201 to be rotatable. The camera module 300 may be disposed to be movable within the rim 201 and/or the hinge structure 400.

The configurations of the frame 200, the display 250, and the camera module 300 of FIG. 4 may be identical or similar to the configurations of the frame 200, the display 250, and the camera 260 (e.g., the recording camera 260-4, 265-4) of FIGS. 2 and 3.

The embodiment of FIG. 4 may be selectively combined with the embodiments of FIGS. 1 to 3 and FIGS. 5 to 24.

According to an embodiment, the camera module 300 may be disposed to be movable within the rim 201 and/or the hinge structure 400. For example, at least a portion of the camera module 300 may be received within a hinge bracket 410 of the hinge structure 400 and may be disposed to be movable within the hinge bracket 410. For example, the camera module 300 may be configured to move in a front lateral direction F toward a front side of the frame 200 and with respect to the rim 201 and/or the hinge structure 400 or a rear lateral direction R toward a rear side of the frame 200 with respect to the rim 201 and/or the hinge structure 400. For example, as the temple 204 rotates with respect to the rim 201, at least a portion (e.g., a portion of a first portion 321) of the camera module 300 may be exposed to the outside of the rim 201 or received inside the rim 201. In case that a portion of the camera module 300 is exposed to the outside of the rim 201, the camera 310 may be in a standby state for an operation (e.g., power ON (camera capturing) or power OFF).

According to an embodiment, the camera module 300 may include a camera 310 and a camera bracket 320. The camera bracket 320 may include a first portion 321 providing a space for receiving the camera 310 and facing the front side in the front lateral direction F, a second portion 322 having a pole 325 guiding movement of the camera bracket 320 and facing the rear side in the rear lateral direction R, and a bridge portion 323 connecting the first portion 321 and the second portion 322.

According to an embodiment, the hinge structure 400 may connect the rim 201 and the temple 204 to be rotatable and may include a guide slot 415 providing a path along which the pole 325 of the camera module 300 moves.

According to an embodiment, the hinge structure 400 may include a hinge bracket 410, a detent 420, and a detent elastic member 430. The hinge bracket 410 includes a front portion 411 and a rear portion 412, and the front portion 411 and the rear portion 412 may be connected to be rotatable about each other. For example, the front portion 411 of the hinge bracket 410 is located within the rim 201, and the rear portion 412 is located within the temple 204 and may connect the rim 201 and the temple 204 to be rotatable. The front portion 411 and the rear portion 412 of the hinge bracket 410 may be rotatably coupled through a first connecting member 440 (e.g., a screw).

According to an embodiment, the front portion 411 of the hinge bracket 410 may provide a space for receiving the camera module 300. The space of the front portion 411 may be formed to allow the camera module 300 to be movable in the front lateral direction F and the rear lateral direction R. The front portion 411 is formed by coupling an upper portion forming an upper side and a lower portion forming a lower side, and the camera bracket 320 receiving the camera 310 may be mounted in the space of the front portion 411.

According to an embodiment, the rear portion 412 of the hinge bracket 410 may provide a space for receiving the detent 420 and the detent elastic member 430. The detent 420 and the detent elastic member 430 may provide a force for maintaining the folded state or the unfolded state of the temple 204 with respect to the rim 201. The detent 420 is a structure for maintaining the folded state or the unfolded state of the temple 204, and the detent elastic member 430 may be a structure for providing tension to maintain the folded state or the unfolded state of the temple 204. According to an embodiment, the detent 420 disposed within the space of the rear portion 412 may contact the front portion 411 of the hinge bracket 410 while providing an elastic force pushing outward by the detent elastic member 430 connected to one side of the detent 420. For example, the detent elastic member 430 is constantly in a compressed state with compression force, and the detent 420 may be configured to maintain the folded state or the unfolded state of the temple 204 with respect to the rim 201 while constantly pressing (e.g., pushing) a flat section provided in the front portion 411 of the hinge bracket 410 by the detent elastic member 430. The rear portion 412 of the hinge bracket 410 and the temple 204 may be coupled through a second connecting member 450 (e.g., a screw).

According to an embodiment, the rear portion 412 of the hinge bracket 410 may have (or include) a guide slot 415 providing a path along which the pole 325 of the camera module 300 moves. The guide slot 415 is disposed adjacent to the first connecting member 440 connecting the front portion 411 and the rear portion 412 of the hinge bracket 410 and may have a shape having a curvature. The pole 325 partially inserted into the guide slot 415 and moving may move the camera module 300 in the front lateral direction F or the rear lateral direction R.

According to an embodiment, the space of the hinge bracket 410 may include an internal structure (e.g., the embedded module 500) disposed adjacent to the camera bracket 320. For example, in case a temple 204 (e.g., a replaceable temple) configured to be detachably attached to the rim 201 is used, the embedded module 500 is disposed as a hook structure 501, and the hook structure 501 may be formed as a structure that facilitates replacement of the temple 204 for the wearable electronic device 101. For example, in case a temple 204 (e.g., a fixed temple) configured to be non-detachably attached to the rim 201 is used, the embedded module 500 may be composed of components such as a sensor and a speaker. Hereinafter, the hook structure 501 as an example of the embedded module 500 is described.

According to an embodiment, the hook structure 501 may include a hook 510, a hook bracket 520, a hook elastic member 530, and/or a hook supporter 540. The hook 510 is a fixing member for coupling with the rim 201 for easy replacement of the temple 204, may be a component protruding toward the rim 201, and may have a designated inclination (or curved surface) formed thereon. The expression ‘hook’ of the hook structure 501 may have various expressions such as a protrusion, a projection portion, a connection portion, or a curve portion.

According to an embodiment, the hook bracket 520 provides a space for receiving the hook 510, the hook elastic member 530, and/or the hook supporter 540 and may be disposed within the front portion 411 of the hinge structure 400. The hook bracket 520 maintains a fixed state within the hinge structure 400 and may be disposed adjacent to the camera module 300. The hook bracket 520 has a form corresponding to a shape of the camera module 300. For example, a portion of the hook bracket 520 may be located between the first portion 321 and the second portion 322 of the camera module 300. For example, a portion of the hook bracket 520 may have a shape inserted into a space having one side opened by the first portion 321, the second portion 322, and the bridge portion 323 of the camera module 300. The hook bracket 520 may be coupled to the front portion 411 of the hinge structure 400 through a third connecting member 550 (e.g., a screw).

According to an embodiment, the hook elastic member 530 is located within the hook bracket 520 and may provide tension for coupling the rim 201 and the temple 204. The hook supporter 540 may be a component for easily transmitting tension of the hook elastic member 530. The hook 510 disposed within the space of the hook bracket 520 may contact the rim 201 while providing an elastic force pushing outward by the hook elastic member 530 connected to one side of the hook 510. For example, the hook elastic member 530 is constantly in a compressed state with compression force, and the hook 510 may be configured to maintain coupling of the temple 204 to the rim 201 while constantly pressing (e.g., pushing) a flat section provided in the accommodation space of the rim 201 by being inserted into the accommodation space of the rim 201 by the hook elastic member 530.

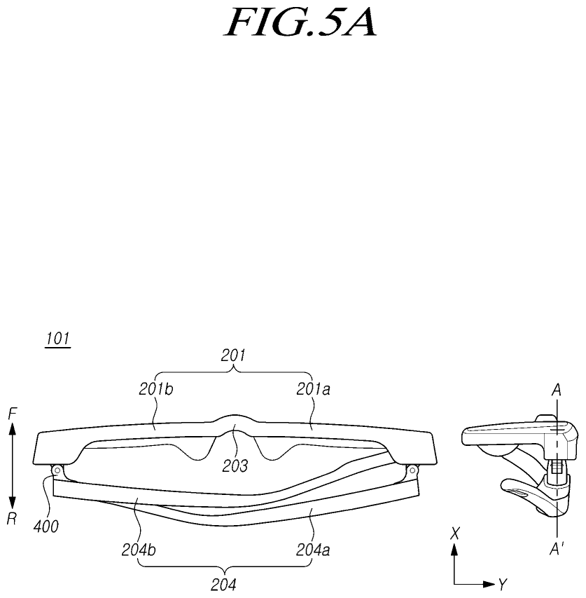

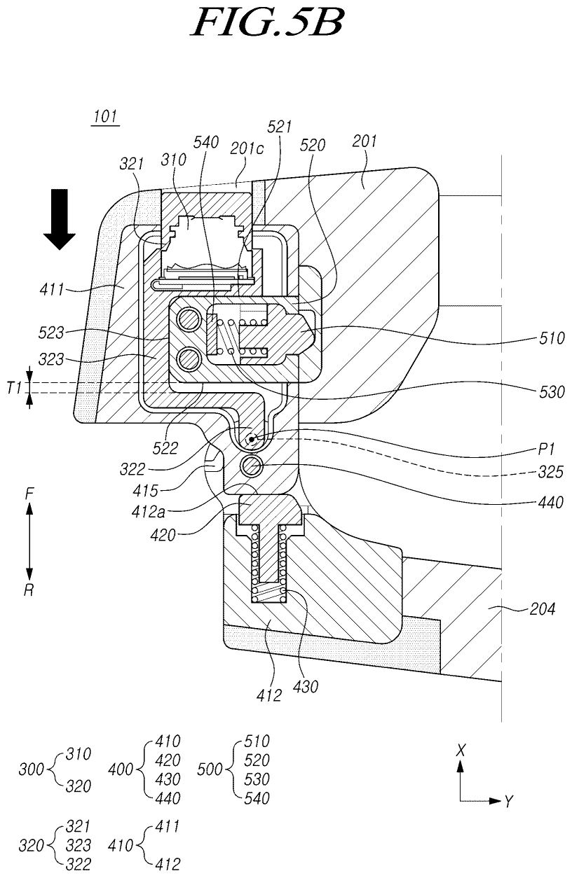

FIG. 5A is a view illustrating an upper surface and a side surface of a wearable electronic device in a folded state of the wearable electronic device according to an embodiment of the disclosure.

FIG. 5B is a cross-sectional view taken along a direction A-A′ from the side surface of FIG. 5A according to an embodiment of the disclosure.

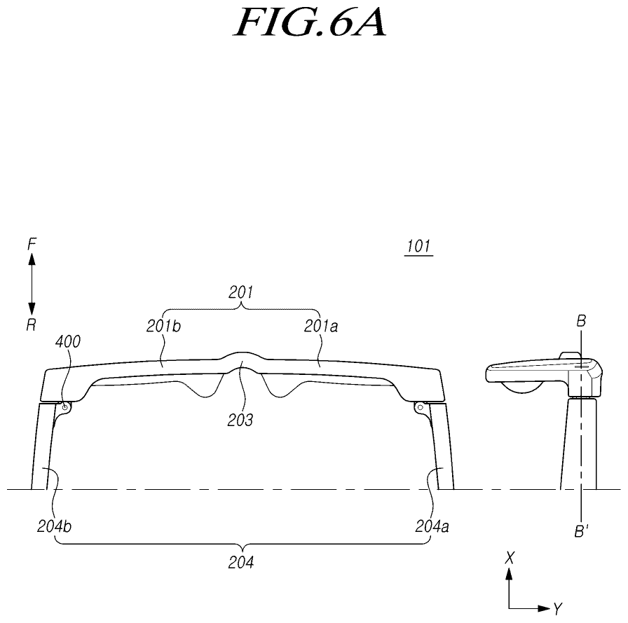

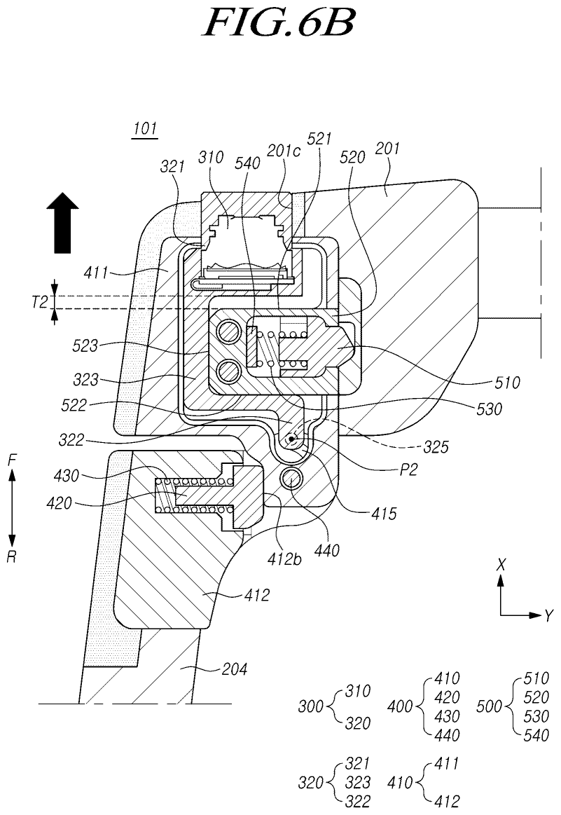

FIG. 6A is a view illustrating an upper surface and a side surface of a wearable electronic device in an unfolded state of the wearable electronic device according to an embodiment of the disclosure.

FIG. 6B is a cross-sectional view taken along a direction B-B′ from the side surface of FIG. 6A according to an embodiment of the disclosure.

According to an embodiment, a wearable electronic device 101 may include a frame 200, a display (e.g., the display 250 of FIG. 4), a camera module 300, a hinge structure 400, and/or an embedded module (e.g., a hook structure 501). The frame 200 may include a rim 201 (e.g., a first rim 201a, a second rim 201b), a bridge 203 disposed between the first rim 201a and the second rim 201b, and a temple 204 (e.g., a first temple 204a, a second temple 204b). The hinge structure 400 may connect the temple 204 to the rim 201 to be rotatable. The camera module 300 is disposed within the rim 201 (or the hinge structure 400) and may move in the front lateral direction F or the rear lateral direction R by rotation of the temple 204.

The configurations of the frame 200, the camera module 300, the hinge structure 400, and the embedded module (e.g., the hook structure 501) of FIGS. 5A to 6B may be identical or similar to the configurations of the frame 200, the camera module 300, the hinge structure 400, and the embedded module 500 (e.g., the hook structure 501) of FIGS. 2 to 4.

The embodiments of FIGS. 5A to 6B may be selectively combined with the embodiments of FIGS. 2 to 4 and FIGS. 7 to 24.

According to an embodiment, a pair of temples 204 (e.g., a first temple 204a and a second temple 204b) are disposed on two opposite sides of the rim 201 and may rotate in different directions (e.g., clockwise or counterclockwise) with respect to the rim 201. The first temple 204a and the second temple 204b may have substantially the same length, but the disclosure is not limited thereto. The first temple 204a and the second temple 204b may have substantially the same width, but the disclosure is not limited thereto.

Hereinafter, an ‘unfolding state’ or an ‘unfolded state (or flat state)’ may refer to a state in which an angle formed by the rim 201 and the temple 204 is substantially 90 degrees. A ‘folding state’ or a ‘folded state’ may refer to a state in which an angle formed by the rim 201 and the temple 204 is substantially 0 degrees. An ‘intermediate state’ may refer to any state between the unfolded state and the folded state.

According to an embodiment, the unfolding state (or the unfolded state) of the wearable electronic device 101 may be understood as the same as the unfolding state (or the unfolded state) of the temple 204 with respect to the rim 201. The folding state (or the folded state) of the wearable electronic device 101 may be understood as the same as the folding state (or the folded state) of the temple 204 with respect to the rim 201.

According to an embodiment, in the unfolded state of the wearable electronic device 101, the first temple 204a and the second temple 204b may be spaced apart from each other and face each other. According to an embodiment, in the folded state of the wearable electronic device 101, the first temple 204a and the second temple 204b may crisscross and contact each other.

According to an embodiment, in the wearable electronic device 101, the rim 201 and the temple 204 may rotate about the hinge structure 400 to form 0 degrees to 90 degrees. According to an embodiment, in the wearable electronic device 101, the rim 201 and the temple 204 may also rotate about the hinge structure 400 to form 90 degrees to 180 degrees.

According to an embodiment, the rim 201 and the temple 204 are connected to be rotatable by the hinge structure 400, and most of the front portion 411 of the hinge structure 400 is located within the rim 201 and most of the rear portion 412 of the hinge structure 400 may be located within the temple 204. A portion of a connection portion of the front portion 411 and the rear portion 412 may be located outside the rim 201 and the temple 204.

According to an embodiment, the camera module 300 and the embedded module 500 (e.g., the hook structure 501) may be disposed in a space formed in the front portion 411 of the hinge structure 400. Hereinafter, the embedded module is described as the hook structure 501 as an example for use as a replaceable temple.

According to an embodiment, the camera module 300 may include a camera 310 and a camera bracket 320. The camera bracket 320 may include a first portion 321 providing a space for receiving the camera 310, a second portion 322 having a pole 325 guiding movement of the camera bracket 320, and a bridge portion 323 connecting the first portion 321 and the second portion 322.

According to an embodiment, the camera 310 may be provided in a state of being received in the first portion 321 of the camera bracket 320, and a portion (e.g., a lens portion) may be disposed to pass through an opening 201c of the rim 201. For example, in case the camera 310 moves in the front lateral direction F, the portion (e.g., the lens portion of the camera 310) may pass through the opening 201c of the rim 201 and be exposed to the outside. For example, in case the camera 310 moves in the rear lateral direction R, the portion (e.g., the lens portion of the camera 310) may be located within the opening 201c of the rim 201.

According to an embodiment, the portions of the camera bracket 320 other than the first portion 321 (e.g., the second portion 322 and the bridge portion 323) are frame-shaped without an inner space and may be structures for providing force transmitted from the pole 325 to the first portion 321 (and the camera 310). The second portion 322 of the camera bracket 320 is a portion having a pole formed for connection to the guide slot 415, and the pole 325 is disposed to face the guide slot 415, and a portion (e.g., an end) may be inserted into the guide slot 415.

According to an embodiment, the hook structure 501 may include a hook 510, a hook bracket 520, a hook elastic member 530, and/or a hook supporter 540. The hook 510 is a fixing member for coupling with the rim 201 for easy replacement of the temple 204, may be a component protruding toward the rim 201, and may have a designated inclination (or curved side or surface) formed thereon. The hook bracket 520 provides a space for receiving the hook 510 and may be disposed to face the camera module 300 in a direction except for the hook 510 protruding toward the rim 201. For example, the hook bracket 520 may include a front side 521, a rear side 522, and a lateral side 523 opposite to the hook 510. The front side 521 of the hook bracket 520 may be disposed to face (e.g., contact or be spaced apart from) the first portion 321 of the camera module 300. The rear side 522 of the hook bracket 520 may be disposed to face (e.g., contact or be spaced apart from) the second portion 322 of the camera module 300. The lateral side 523 of the hook bracket 520 may be disposed to face (e.g., contact or be spaced apart from) the bridge portion 323 of the camera module 300.

Referring to FIGS. 5A and 5B, in the folded state of the wearable electronic device 101, the camera module 300 (e.g., the camera 310) may be located within the rim 201. In the folded state of the wearable electronic device 101, the camera module 300 (e.g., the camera 310) may not be exposed to the outside. The folded state of the wearable electronic device 101 may be a state in which a user is not wearing the wearable electronic device 101.

According to an embodiment, the camera 310 is in a state of being fixed within the camera bracket 320, and according to movement of the camera bracket 320, the camera 310 may move in the front lateral direction F or the rear lateral direction R. In case the wearable electronic device 101 operates from the unfolded state to the folded state, the camera module 300 (e.g., the camera 310) may move in the rear lateral direction R within a space of the hinge structure 400.

According to an embodiment, in case the wearable electronic device 101 operates from the unfolded state to the folded state, the camera module 300 may slide in the rear lateral direction R with respect to the hook structure 501 having a fixed position. For example, in case the wearable electronic device 101 operates from the unfolded state to the folded state, the camera 310 may move toward the hook structure 501. For example, the first portion 321 and the second portion 322 of the camera bracket 320 are shaped to be spaced apart with the hook structure 501 therebetween and, in case the wearable electronic device 101 operates from the unfolded state to the folded state, the first portion 321 may move toward the hook structure 501, and the second portion 322 may move away from the hook structure 501.

According to an embodiment, in the folded state of the wearable electronic device 101, the camera 310 and the first portion 321 of the camera bracket 320 receiving the camera 310 may be located inside the hinge structure 400 and within the opening 201c of the rim 201. For example, a front end of the first portion 321 of the camera bracket 320 is located within the opening 201c of the rim 201, and a rear end of the first portion 321 of the camera bracket 320 may be in a state of contacting the front side 521 of the hook bracket 520.

According to an embodiment, in the folded state of the wearable electronic device 101, the second portion 322 of the camera bracket 320 may be spaced apart from the rear side 522 of the hook bracket 520. For example, the second portion 322 of the camera bracket 320 may face the rear side 522 of the hook bracket 520 and maintain a state of being spaced apart by a first length T1.

According to an embodiment, in the folded state of the wearable electronic device 101, at least a portion of the pole 325 formed on the second portion 322 of the camera bracket 320 may be in a state of being inserted into the first position P1 of the guide slot 415.

According to an embodiment, in the folded state of the wearable electronic device 101, the detent 420 received within the temple 204 may contact one side or surface (e.g., a first side 412a) (e.g., one side or surface facing a direction toward an X-axis) facing the rear of the hinge structure 400. For example, the detent 420 may be configured to maintain the folded state of the temple 204 with respect to the rim 201 while providing an elastic force to the first surface 412a (e.g., one side or surface facing a direction toward an X-axis) of the hinge structure 400 by the detent elastic member 430 connected to one side.

According to an embodiment, in the folded state of the wearable electronic device 101, the camera 310 of the camera module 300 may be in an inactive state.

Referring to FIGS. 6A and 6B, in the unfolded state of the wearable electronic device 101, the camera module 300 (e.g., the camera 310) may be exposed to the outside of the rim 201. The camera module 300 exposed to the outside may provide a wide viewing angle. The unfolded state of the wearable electronic device 101 may be a state in which a user is wearing the wearable electronic device 101.

According to an embodiment, the camera 310 is in a state of being fixed within the camera bracket 320, and according to movement of the camera bracket 320, the camera 310 may move in the front lateral direction F or the rear lateral direction R. In case the wearable electronic device 101 operates from the folded state to the unfolded state, the camera module 300 (e.g., the camera 310) may move in the front lateral direction F within the space of the hinge structure 400.

According to an embodiment, in case the wearable electronic device 101 operates from the folded state to the unfolded state, the camera module 300 may slide in the front lateral direction F with respect to the hook structure 501 having a fixed position. For example, in case the wearable electronic device 101 operates from the folded state to the unfolded state, the camera 310 may move in the front lateral direction F away from the hook structure 501. For example, the first portion 321 and the second portion 322 of the camera bracket 320 are shaped to be spaced apart with the hook structure 501 therebetween and, in case the wearable electronic device 101 operates from the folded state to the unfolded state, the first portion 321 may move away from the hook structure 501, and the second portion 322 may move toward the hook structure 501.

According to an embodiment, in the unfolded state of the wearable electronic device 101, the camera 310 and the first portion 321 of the camera bracket 320 receiving the camera 310 may be located to pass through the inside of the hinge structure 400 and the opening 201c of the rim 201. For example, a front end of the first portion 321 of the camera bracket 320 is located to be exposed to the outside of the opening 201c of the rim 201, and a rear end of the first portion 321 of the camera bracket 320 may be in a state of being spaced apart from the front side 521 of the hook bracket 520. For example, a rear end of the second portion 322 of the camera bracket 320 may face the front side 521 of the hook bracket 520 and maintain a state of being spaced apart by a second length T2. The second length T2 may be equal to the first length T1.

According to an embodiment, in the unfolded state of the wearable electronic device 101, the second portion 322 of the camera bracket 320 may be disposed in contact with the rear side 522 of the hook bracket 520.

According to an embodiment, in the unfolded state of the wearable electronic device 101, at least a portion of the pole 325 formed on the second portion 322 of the camera bracket 320 may be in a state of being inserted into the second position P2 of the guide slot 415. The second position P2 may be in a state of being moved in the front lateral direction F compared to the first position P1.

According to an embodiment, in the unfolded state of the wearable electronic device 101, the detent 420 received within the temple 204 may contact one side or surface (e.g., a second side 412b) (e.g., one side or surface facing a direction toward a Y-axis) facing the outside of the hinge structure 400. For example, the detent 420 may be configured to maintain the unfolded state of the temple 204 with respect to the rim 201 while providing an elastic force to the second side 412b (e.g., one side or surface facing a direction toward a Y-axis) of the hinge structure 400 by the detent elastic member 430 connected to one side.

According to an embodiment, in the folded state of the wearable electronic device 101, the camera 310 of the camera module 300 may be in an active state. The active state may be a standby state in which the camera 310 is capable of capturing images.

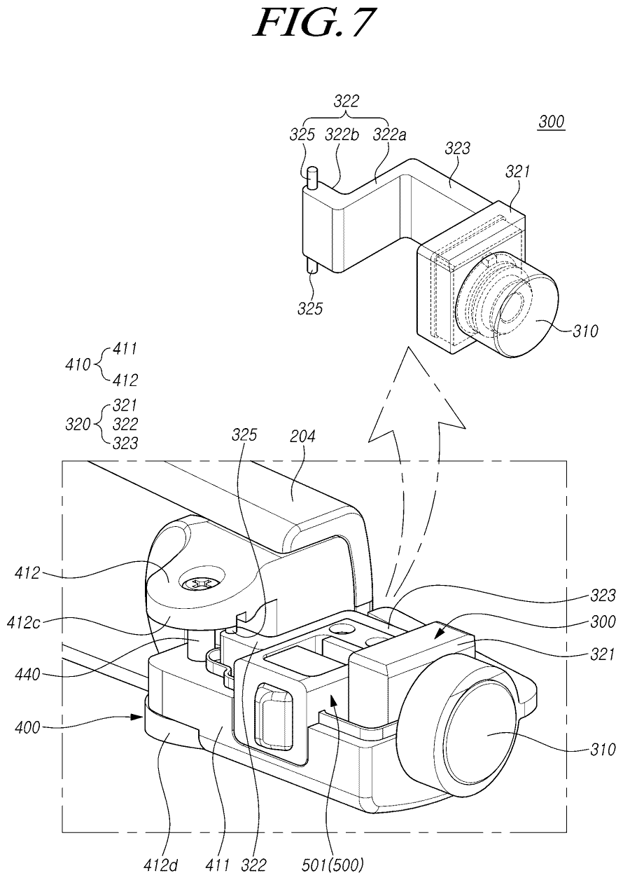

FIG. 7 is a perspective view illustrating a camera module located within a hinge structure of a wearable electronic device according to an embodiment of the disclosure.

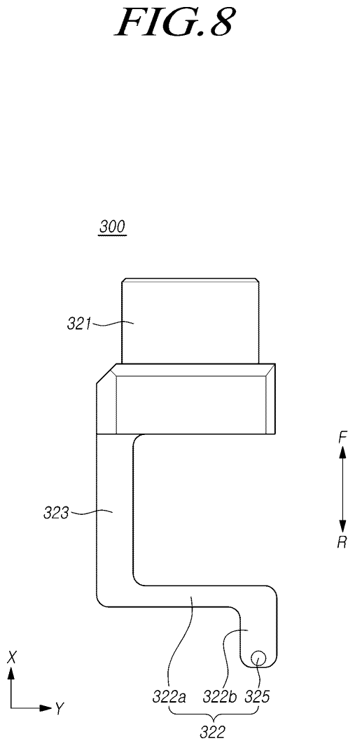

FIG. 8 is a view illustrating a camera module viewed from an upper side according to an embodiment of the disclosure.

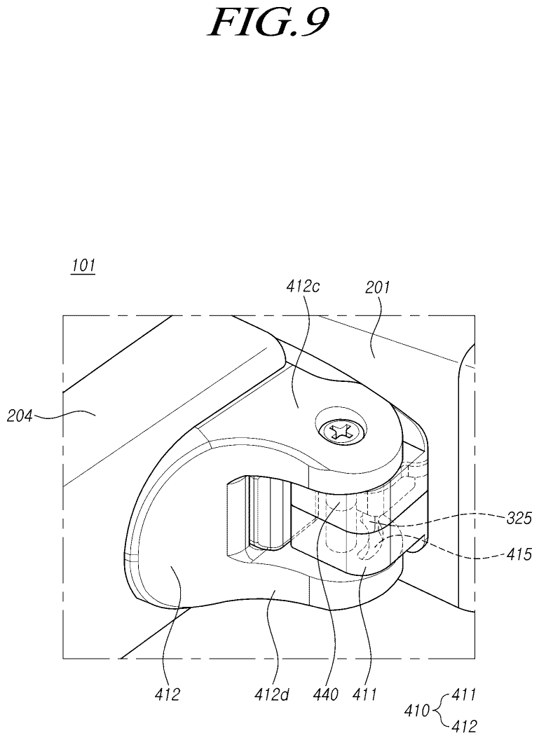

FIG. 9 is a projection view illustrating a connection structure between a guide slot and a pole in an unfolded state of a wearable electronic device according to an embodiment of the disclosure.

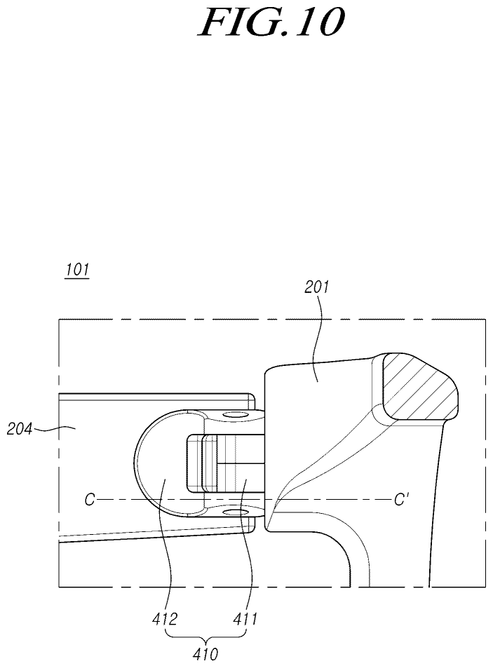

FIG. 10 is a view illustrating a hinge structure viewed toward a rear lateral direction in an unfolded state of a wearable electronic device according to an embodiment of the disclosure.

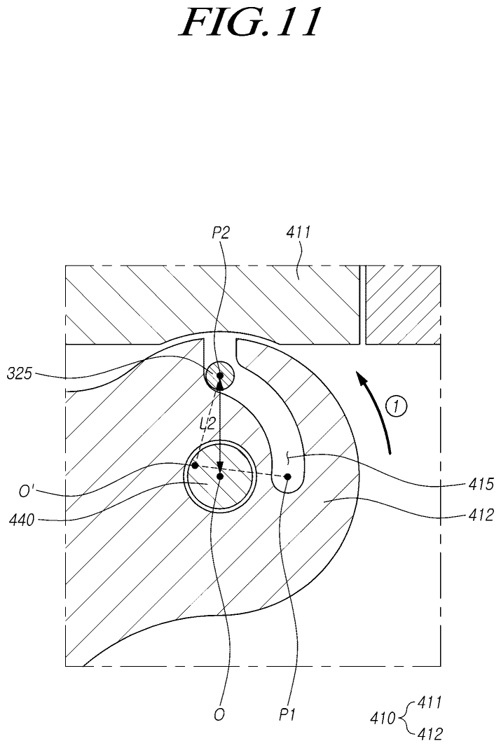

FIG. 11 is a cross-sectional view taken along a direction C-C′ of FIG. 10 in an unfolded state of a wearable electronic device according to an embodiment of the disclosure.

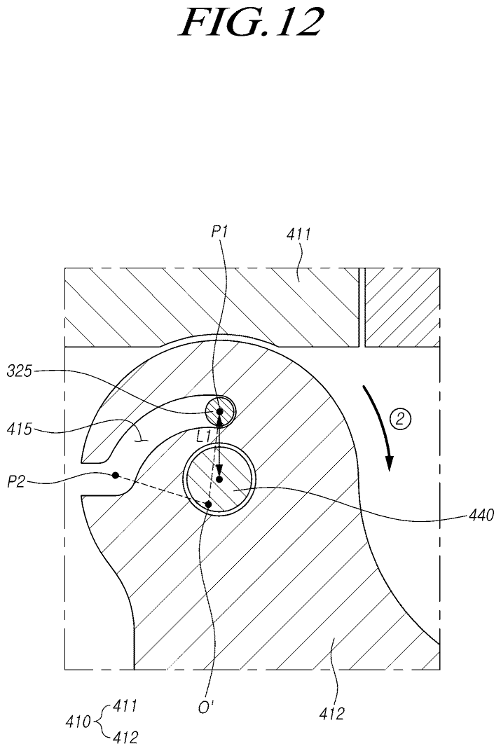

FIG. 12 is a cross-sectional view taken along a direction C-C′ of FIG. 10 in a folded state of a wearable electronic device according to an embodiment of the disclosure.

According to an embodiment, a wearable electronic device 101 may include a frame 200, a display (e.g., the display 250 of FIG. 4), a camera module 300, a hinge structure 400, and/or an embedded module (e.g., a hook structure 501). The frame 200 may include a rim 201 (e.g., the first rim 201a of FIG. 4, the second rim 201b), a bridge 203 disposed between the first rim 201a and the second rim 201b, and a temple 204 (e.g., the first temple 204a of FIG. 4, the second temple 204b). The hinge structure 400 may connect the temple 204 to the rim 201 to be rotatable. The camera module 300 may move in the front lateral direction F or the rear lateral direction R within the rim 201 and/or the hinge structure 400.

The configurations of the frame 200, the camera module 300, the hinge structure 400, and the embedded module (e.g., the hook structure 501) of FIGS. 8 to 12 may be identical or similar to the configurations of the frame 200, the camera module 300, the hinge structure 400, and the embedded module 500 (e.g., the hook structure 501) of FIGS. 2 to 7.

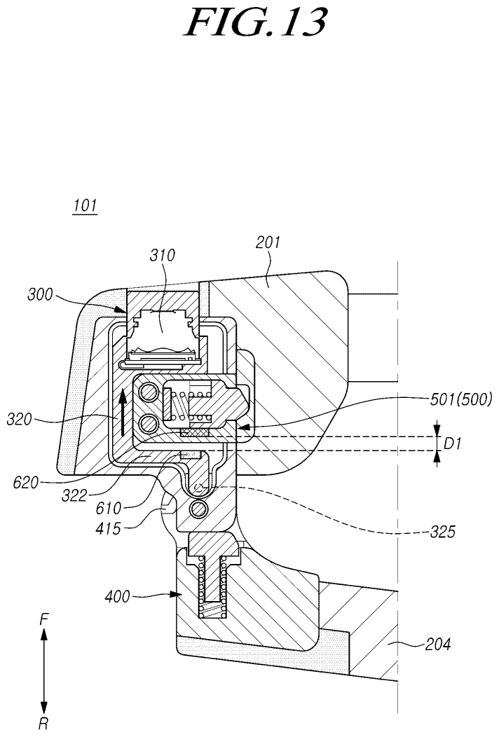

The embodiments of FIGS. 8 to 12 may be selectively combined with the embodiments of FIGS. 1 to 7, and the embodiments of FIGS. 13 to 24.

According to an embodiment, in the wearable electronic device 101, the rim 201 and the temple 204 may rotate about the hinge structure 400 to form 0 degrees to 90 degrees.

According to an embodiment, the camera module 300 and the embedded module 500 (e.g., the hook structure 501) may be disposed in a space formed in the front portion 411 of the hinge structure 400. Hereinafter, the embedded module 500 is described as the hook structure 501 as an example for use as a replaceable temple.

According to an embodiment, the camera module 300 may include a camera 310 and a camera bracket 320. The camera bracket 320 may include a first portion 321 providing a space for receiving the camera 310, a second portion 322 having a pole 325 guiding movement of the camera bracket 320, and a bridge portion 323 connecting the first portion 321 and the second portion 322.

According to an embodiment, the shape of the camera bracket 320 may be provided in a partially curved shape to provide a space for disposing components (e.g., the hook structure 501) other than the camera 310 within the hinge structure 400 and to connect one end (e.g., the pole 325) to the rear portion 412 of the hinge bracket 410. For example, the first portion 321 of the camera bracket 320 may be a housing shape providing a space for receiving the camera 310. For example, the bridge portion 323 and the second portion 322 of the camera bracket 320 may be frames extended to be curved along an edge of the hinge structure 400.

According to an embodiment, the bridge portion 323 of the camera bracket 320 extends from one end of the first portion 321 and may be disposed along an edge of the space of the hinge bracket 410. The bridge portion 323 of the camera bracket 320 may extend lengthwise in the rear lateral direction R from one end of the first portion 321. The bridge portion 323 may connect to the first portion 321 and the second portion 322. The bridge portion 323 may extend along between an edge of the hinge structure 400 and the hook structure 501.

According to an embodiment, the second portion 322 of the camera bracket 320 is disposed along an edge of the space of the hinge bracket 410 and may extend from one end of the bridge portion 323 to be adjacent to the first connecting member 440 forming a hinge axis. The second portion 322 may include a first frame 322a, a second frame 322b, and a pole 325. The first frame 322a is formed with a thickness corresponding to the bridge portion 323 and may extend in a direction (e.g., a Y-axis direction) perpendicular to the bridge portion 323. The embedded module (e.g., the hook structure 501) may be disposed in a space formed by the bridge portion 323 and the first frame 322a. The second frame 322b is formed with a thickness corresponding to the first frame 322a (or the bridge portion 323) and may extend in a direction (e.g., the rear lateral direction R) perpendicular to the first frame 322a. A portion of the second frame 322b may be located between sides (e.g., surfaces) formed by the rear portion 412 of the hinge bracket 410.

According to an embodiment, the pole 325 may have a shape protruding to two opposite sides (or one side) from one end of the second frame 322b. For example, the pole 325 may extend from one end of the second frame 322b in a downward direction (and/or an upward direction). The pole 325 may be inserted into the guide slot 415 and slide, and movement of the pole 325 may move the camera bracket 320 (and the camera 310) in the front lateral direction F or the rear lateral direction R. The pole 325 may extend in a direction parallel to the first connecting member 440 forming a hinge axis. The pole 325 may move in a direction surrounding at least a portion of the first connecting member 440 according to a shape of the guide slot 415.

According to an embodiment, the hinge structure 400 may include a hinge bracket 410 receiving the camera module 300 and the first connecting member 440. The hinge bracket 410 includes a front portion 411 and a rear portion 412, and the front portion 411 and the rear portion 412 may be connected to be rotatable about each other. For example, the front portion 411 of the hinge bracket 410 is located within the rim 201, and the rear portion 412 is located within the temple 204 and may connect the rim 201 and the temple 204 to be rotatable.

According to an embodiment, the first connecting member 440 (e.g., a screw) may rotatably connect the front portion 411 and the rear portion 412 of the hinge bracket 410. The first connecting member 440 may provide a role of a hinge axis so that the temple 204 may rotate in a clockwise direction (or counterclockwise direction) with respect to the rim 201.

According to an embodiment, the rear portion 412 of the hinge bracket 410 may include (or form) a guide slot 415 guiding movement of the pole 325 of the camera bracket 320. The guide slot 415 has a width corresponding to a shape (e.g., a diameter) of the pole 325 and may form a curved slot. The guide slot 415 may be formed along an edge of the first connecting member 440. For example, the guide slot 415 may be formed as if surrounding a portion of the first connecting member 440 forming a hinge axis.

According to an embodiment, the rear portion 412 of the hinge bracket 410 may include an upper frame 412c and a lower frame 412d spaced apart from each other so that a portion of the front portion 411 may be fitted and coupled between the upper frame 412c and the lower frame 412d. The guide slot 415 may be formed in the upper frame 412c and/or the lower frame 412d according to a shape (e.g., number) of the pole 325. For example, in case the pole 325 has a structure protruding in a downward direction, the guide slot 415 may have a recess shape concavely formed in the lower frame 412d so that the pole 325 may be inserted. For example, in case the pole 325 has a structure protruding in an upward direction and a downward direction, the guide slot 415 may have a recess shape concavely formed in the upper frame 412c and a recess shape concavely formed in the lower frame 412d so that the poles 325 may be inserted, respectively.

According to an embodiment (e.g., see FIGS. 10 and 11), by an unfolding operation of the temple 204 with respect to the rim 201 (e.g., from the folded state to the unfolded state), the rim 201 rotates in a first direction \textcircled{1} with respect to the temple 204, and the pole 325 may slide along the guide slot 415.

According to an embodiment, during the unfolding operation of the wearable electronic device 101, the temple 204 with respect to the rim 201 may rotate (e.g., rotate in the first direction \textcircled{1}) about a hinge axis O (e.g., the first connecting member 440) located in the rear portion 412 of the hinge bracket 410. During the unfolding operation (e.g., refer to FIGS. 5B and 6B), the detent 420 of the hinge structure 400 may maintain the unfolded state of the temple 204 with respect to the rim 201 by moving from a rear side (e.g., a first side 411a) to a lateral side (e.g., a second side 411b) of the front portion 411 of the hinge structure 400 and then providing an elastic force toward the lateral side (e.g., the second side 411b). In the unfolded state, an outer side (e.g., surface) of the rear portion 412 of the hinge structure 400 may form a side (e.g., surface) (e.g., a smoothly connected same side or surface) corresponding to an outer side (e.g., surface) of the front portion 411.

According to an embodiment, during the unfolding operation of the wearable electronic device 101, the pole 325 formed on the camera bracket 320 (e.g., the second portion 322) may move along the guide slot 415 formed in the hinge bracket 410 (e.g., the rear portion 412). The guide slot 415 may be formed to surround a portion of the hinge axis O. For example, the guide slot 415 may be disposed as a concave groove along an edge of the hinge axis O while forming a long extended curved side (e.g., surface) (or inclined side or surface) with one side opened.

According to an embodiment, during the unfolding operation of the wearable electronic device 101, a central axis O′ of the guide slot 415 may not coincide with (or be aligned with) the hinge axis O (e.g., a center of the first connecting member 440). For example, the central axis O′ of the guide slot 415 may be located closer to an inner side of the hinge bracket 410 (e.g., the rear portion 412) than the hinge axis O.

According to an embodiment, the guide slot 415 does not form a perfect circle unlike the hinge axis O and may have a curvature value that varies according to length.

According to an embodiment, during the unfolding operation of the wearable electronic device 101, the pole 325 of the camera bracket 320 may move from the first position P1 to the second position P2 of the guide slot 415. For example, when viewed from the pole 325 (or considering only rotational movement of the guide slot 415 with respect to the pole 325), due to the unfolding operation, the pole 325 may move in the front lateral direction F. The movement of the pole 325 fixed to the camera bracket 320 in the front lateral direction F may move the camera 310 in the front lateral direction F. The movement of the camera 310 in the front lateral direction F may expose a portion of the camera 310 (or a portion of a lens of the camera 310) to the outside of the rim 201 to switch the camera 310 to a state capable of capturing images.

According to an embodiment, during the unfolding operation of the wearable electronic device 101, the pole 325 of the camera bracket 320 may move from the first position P1 to the second position P2 of the guide slot 415. For example, when viewed from the guide slot 415 (or fixing the guide slot 415 and considering movement of the pole 325), during the unfolding operation, a distance between a position of the pole 325 and the hinge axis O may sequentially increase. The pole 325 rotates and slides along the guide slot 415, and a second distance L2 between the second position P2 of the pole 325 in the unfolded state and the hinge axis O may be greater than a first distance L1 between the first position P1 of the pole 325 in the folded state and the hinge axis O.

According to an embodiment (e.g., see FIG. 12), by a folding operation of the temple 204 with respect to the rim 201 (e.g., from the unfolded state to the folded state), the rim 201 rotates in a second direction \textcircled{2} opposite to the first direction \textcircled{1} with respect to the temple 204, and the pole 325 may slide along the guide slot 415.

According to an embodiment, during the folding operation of the wearable electronic device 101, the temple 204 with respect to the rim 201 may rotate (e.g., rotate in the second direction \textcircled{2} about the hinge axis O (e.g., the first connecting member 440) located in the rear portion 412 of the hinge bracket 410. During the folding operation (e.g., refer to FIGS. 5B and 6B), the detent 420 of the hinge structure 400 may maintain the folded state of the temple 204 with respect to the rim 201 by moving from a lateral side (e.g., surface) (e.g., the second side 411b) to a rear side (e.g., surface) (e.g., the first side 411a) of the front portion 411 of the hinge structure 400 and then providing an elastic force toward the rear side (e.g., the first side 411a). In the folded state, an outer surface of the rear portion 412 of the hinge structure 400 may form sides (e.g., surfaces) (e.g., surfaces facing different directions from each other) differently extending from an outer side (e.g., surface) of the front portion 411.

According to an embodiment, during the folding operation of the wearable electronic device 101, the pole 325 formed on the camera bracket 320 (e.g., the second portion 322) may move along the guide slot 415 formed in the hinge bracket 410 (e.g., the rear portion 412). The guide slot 415 may be formed to surround a portion of the hinge axis O. For example, the guide slot 415 may be disposed as a concave groove along an edge of the hinge axis O while forming a long extended curved side (e.g., surface) (or inclined side or surface) with one side opened.

According to an embodiment, during the folding operation of the wearable electronic device 101, the central axis O′ of the guide slot 415 may not coincide with the hinge axis O (e.g., a center of the first connecting member 440). For example, the central axis O′ of the guide slot 415 may be located closer to an inner side of the hinge bracket 410 (e.g., the rear portion 412) than the hinge axis O.

According to an embodiment, the guide slot 415 does not form a perfect circle unlike the hinge axis O and may have a curvature value that varies according to length.

According to an embodiment, during the folding operation of the wearable electronic device 101, the pole 325 of the camera bracket 320 may move from the second position P2 to the first position P1 of the guide slot 415. For example, when viewed from the pole 325 (or considering only rotational movement of the guide slot 415 with respect to the pole 325), due to the folding operation, the pole 325 may move in the rear lateral direction R. The movement of the pole 325 fixed to the camera bracket 320 in the rear lateral direction R may move the camera 310 in the rear lateral direction R. The movement of the camera 310 in the rear lateral direction R may switch the camera 310 to a standby state other than capturing or a power off state and receive the camera 310 entirely inside the rim 201 so as not to be exposed to the outside, thereby protecting the camera 310.

According to an embodiment, during the folding operation of the wearable electronic device 101, the pole 325 of the camera bracket 320 may move from the second position P2 to the first position P1 of the guide slot 415. For example, when viewed from the guide slot 415 (or fixing the guide slot 415 and considering movement of the pole 325), during the folding operation, a distance between a position of the pole 325 and the hinge axis O may sequentially decrease. During the folding operation, the pole 325 rotates and slides along the guide slot 415, and a first distance L1 between the first position P1 of the pole 325 in the folded state and the hinge axis O may be smaller than a second distance L2 between the second position P2 of the pole 325 in the unfolded state and the hinge axis O.

FIG. 13 is a view illustrating a distance between a magnet and a sensor in a folded state of a wearable electronic device according to an embodiment of the disclosure.

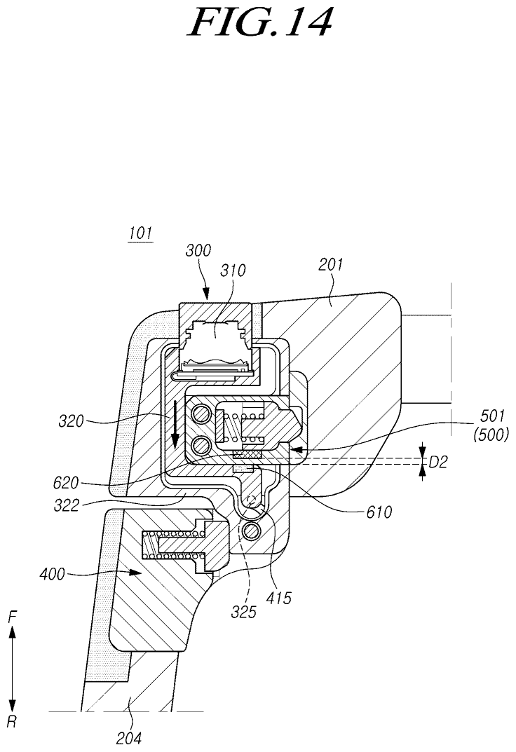

FIG. 14 is a view illustrating a distance between a magnet and a sensor in an unfolded state of a wearable electronic device according to an embodiment of the disclosure.

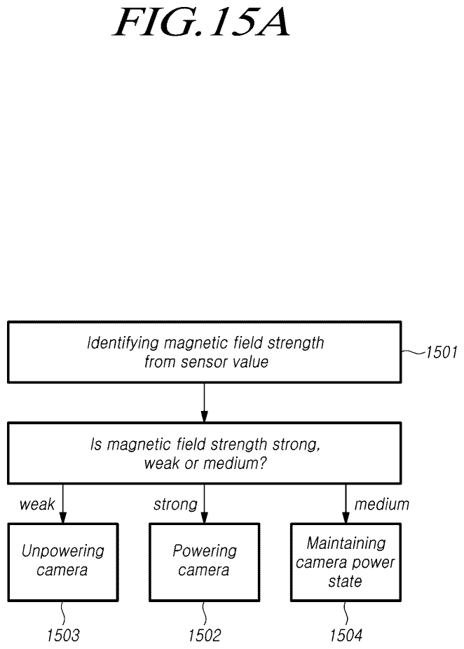

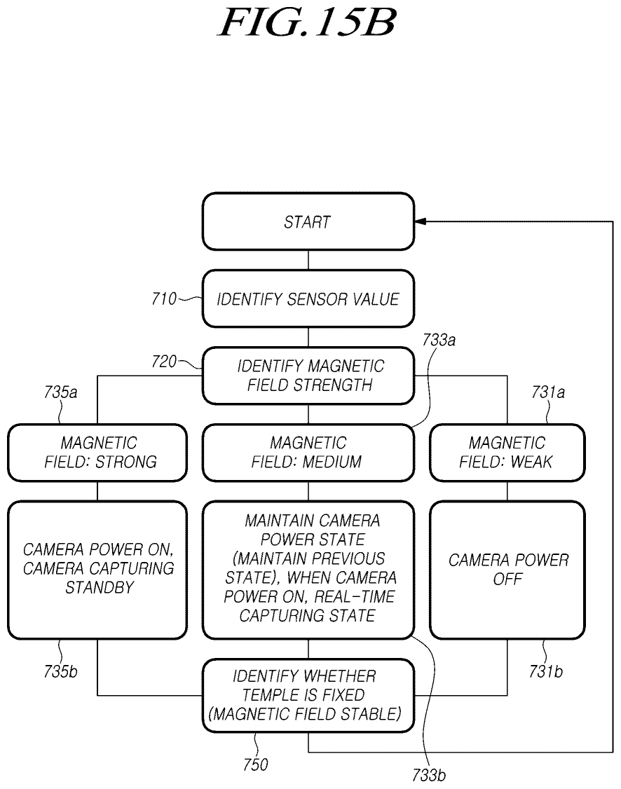

FIG. 15A is a flowchart illustrating a method of operating a camera of a wearable electronic device configured to assume a folded state unsuitable for being worn by a user, an unfolded state suitable for being worn by the user and an intermediate state between the folded and unfolded states according to an embodiment of the disclosure.

FIG. 15B is a flowchart illustrating an operation of a camera module for an unfolding/folding operation of a wearable electronic device according to an embodiment of the disclosure.

According to an embodiment, a wearable electronic device 101 may include a frame 200, a display (e.g., the display 250 of FIG. 4), a camera module 300, a hinge structure 400, and/or an embedded module (e.g., a hook structure 501). The frame 200 may include a rim 201 (e.g., the first rim 201a of FIG. 4, the second rim 201b), a bridge 203 disposed between the first rim 201a and the second rim 201b, and a temple 204 (e.g., the first temple 204a of FIG. 4, the second temple 204b). The hinge structure 400 may connect the temple 204 to the rim 201 to be rotatable. The camera module 300 may move in the front lateral direction F or the rear lateral direction R within the rim 201 and/or the hinge structure 400.

The configurations of the frame 200, the camera module 300, the hinge structure 400, and the embedded module (e.g., the hook structure 501) of FIGS. 13 to 15 may be identical or similar to the configurations of the frame 200, the camera module 300, the hinge structure 400, and the embedded module 500 (e.g., the hook structure 501) of FIGS. 2 to 12.

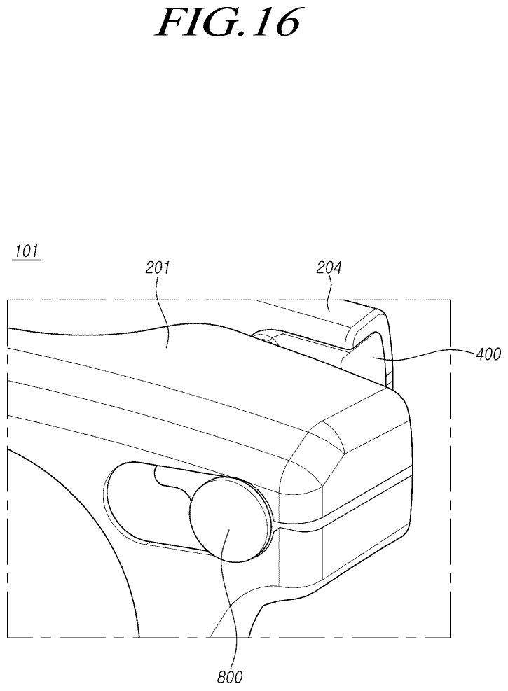

The embodiments of FIGS. 13 to 15 may be selectively combined with the embodiments of FIGS. 1 to 12, and the embodiments of FIGS. 16 to 24.

According to an embodiment, the wearable electronic device 101 may further include a magnet 610, a sensor 620, a memory (e.g., the memory 130 of FIG. 1), and a processor (e.g., the processor 120 of FIG. 1) as tools for control of the camera module 300. According to an embodiment, the rim 201 and the temple 204 may rotate about the hinge structure 400 to form 0 degrees to 90 degrees, and according to the rotation, a distance between the magnet 610 and the sensor 620 may vary. A change in distance between the magnet 610 and the sensor 620 may switch the state of the camera module 300 to various modes by the wearable electronic device 101 (or the processor 120).

According to an embodiment, the embedded module 500 may be disposed adjacent to the camera module 300 within the rim 201 (or the hinge structure 400). The embedded module 500 may be variously designed and changed according to a type of the temple 204. For example, in case a temple 204 (e.g., a replaceable temple) configured to be detachably attached to the rim 201 is used, the embedded module 500 is disposed as a hook structure 501, and the hook structure 501 may be configured as a structure that facilitates replacement of the temple 204. For example, in case a temple 204 (e.g., a fixed temple) configured to be non-detachably attached to the rim 201 is used, the embedded module 500 may be composed of components such as a magnet, a sensor, and/or a speaker.

According to an embodiment, the magnet 610 is a component generating a magnetic field and may be located within the camera module 300. The magnet 610 may be disposed to face the embedded module 500. For example, the magnet 610 may be located on the camera bracket 320 so that the magnetic field may be easily recognized by the sensor 620. For example, the magnet 610 may be disposed at an edge of the second portion 322 of the camera bracket 320 to face the sensor 620 disposed in the embedded module 500. The magnet 610 may move in the front lateral direction F or the rear lateral direction R in response to movement of the camera module 300 in the front lateral direction F or the rear lateral direction R.

According to an embodiment, the magnet 610 is a permanent magnet (e.g., neodymium or ferrite) generating a constant magnetic field, and is attached to one side of the camera module 300 connected to the hinge structure 400 of the wearable electronic device 101, and a relative position with respect to the sensor 620 may vary according to a rotation angle of the temple 204 with respect to the rim 201. A change in magnetic field strength resulting therefrom is detected by the sensor 620 and may cause a state transition (or motion recognition) of the camera module 300. The magnet 610 may be a component that enables non-contact detection and has a simple and excellent durability configuration without requiring a separate power source. In some cases, the magnet 600 may also be an electromagnet that receives electric current from a source, such as one of the plurality of battery modules 270.

According to an embodiment, the sensor 620 is disposed adjacent to the camera module 300 and may interact with the magnet 610 disposed in the camera module 300. The sensor 620 may be located within the embedded module 500. The sensor 620 is disposed facing the magnet 610 and may have a fixed position.

According to an embodiment, the sensor 620 is a component detecting a strength of a magnetic field generated by the magnet 610, and for example, a hall sensor may be used. The sensor 620 provides output values that vary according to a relative distance or position change from the magnet 610 and may provide reference information for determining an operation state of the wearable electronic device 101 (e.g., the camera 310). The sensor 620 is small and has high precision and may enable non-contact detection in combination with the magnet 610.

In FIGS. 13 and 14, a state in which the magnet 610 is disposed on one side of the camera module 300 and the sensor 620 is disposed on one side of the embedded module 500 is disclosed, but the disclosure is not limited thereto. For example, a magnet 610 is disposed on one side of the embedded module 500 and located to face the magnet 610 disposed in the camera module 300, and various structures for mutual relationship between the magnet 610 and the sensor 620 may be designed and changed.

According to an embodiment, the wearable electronic device 101 may include a processor (e.g., the processor 120 of FIG. 1) including processing circuitry and electrically connected to a memory (e.g., the memory 130 of FIG. 1). The processor 120 may execute software to control at least one other component (e.g., a hardware or software component) of the wearable electronic device 101 connected to the processor 120 and may perform various data processing or operations.

According to an embodiment, the software component may be stored in a non-transitory computer-readable storage medium. The non-transitory computer-readable storage medium stores one or more computer programs (software modules), and the one or more computer programs include computer-executable instructions and, when the instructions are executed by one or more processors 120 of the wearable electronic device 101 individually or collectively, the wearable electronic device 101 may perform the method disclosed below.

According to an embodiment, according to a rotation operation of the temple 204 with respect to the rim 201, a user may wear or release (e.g., take off) the wearable electronic device 101. According to a rotation operation of the temple 204 with respect to the rim 201, the camera module 300 may move in the front lateral direction F or the rear lateral direction R within the rim 201. The movement of the camera module 300 enables a portion (e.g., a lens) of the camera 310 to be exposed to the outside, and a state of the camera module 300 may be controlled differently by the processor 120.

According to an embodiment, the state of the camera module 300 may be classified into a power ON state or a power OFF state and may be controlled by the wearable electronic device 101 (hereinafter, described as the processor 120). The power ON state may include a camera capturing standby state or a real-time capturing state (e.g., a black box mode). The power OFF state may be a state in which the camera module is deactivated and all capturing-related functions are stopped.

Hereinafter, referring to the flowcharts of FIG. 15A and FIG. 15B, movement and a state of the camera module 300 is described.

As shown in FIG. 15A, a method 1500 of operating a camera of a wearable electronic device configured to assume a folded state unsuitable for being worn by a user, an unfolded state suitable for being worn by the user and an intermediate state between the folded and unfolded states is provided. The method 1500 includes identifying a magnetic field strength from a sensor value (1501), powering the camera in an event the magnetic field strength is identified as being strong in a case in which the wearable electronic device assumes the unfolded state (1502), unpowering the camera in an event the magnetic field strength is identified as being weak in a case in which the wearable electronic device assumes the folded state (1503) and maintaining a camera power state in an event the magnetic field strength is identified as being medium in a case in which the wearable electronic device assumes the intermediate state (1504).

According to an embodiment, in the folded state of the wearable electronic device 101 (or the folded state of the temple 204 with respect to the rim 201), a user may be in a state of not wearing the wearable electronic device 101. In the folded state of the wearable electronic device 101, the pole 325 of the camera module 300 may be in a state of being moved in the rear lateral direction R along the guide slot 415 of the hinge structure 400. The movement of the pole 325 of the camera module 300 in the rear lateral direction R moves the camera module 300 entirely in the rear lateral direction R, and the camera 310 may be located so as not to be exposed to the outside. For example, the camera 310 may be in a state of being withdrawn inside the rim 201.

According to an embodiment, in the folded state of the wearable electronic device 101 (or the folded state of the temple 204 with respect to the rim 201), a distance between the magnet 610 of the camera module 300 and the sensor 620 of the embedded module 500 may have a relatively far gap D1 compared to other states (e.g., an intermediate state, an unfolded state) of the wearable electronic device 101. The sensor 620 detects the strength of a magnetic field generated by the magnet 610 and may transmit information (e.g., a sensor value) regarding the magnetic field strength to the wearable electronic device 101 (hereinafter, described as the processor 120).

According to an embodiment, in the folded state of the wearable electronic device 101 (or the folded state of the temple 204 with respect to the rim 201), the processor 120 may perform an operation of receiving and identifying a sensor value obtained from the sensor 620 (operation 710). For example, the processor 120 may periodically receive a voltage signal from the sensor 620. The voltage signal may be transmitted as an analog value proportional to a magnetic field strength. The signal may be converted to digital data through an analog-to-digital converter. The converted digital value may be stored in an internal register or memory space of the processor 120. The processor 120 may prepare to determine presence or strength of a magnetic field based on the digital value.

According to an embodiment, in the folded state of the wearable electronic device 101 (or the folded state of the temple 204 with respect to the rim 201), the processor 120 may perform an operation of identifying or determining a current magnetic field strength based on the transmitted (or stored) sensor value (operation 720). For example, the processor 120 may classify which range of strong, medium, or weak the magnetic field belongs to by comparing to predefined (or set) thresholds.

According to an embodiment, in the folded state of the wearable electronic device 101 (or the folded state of the temple 204 with respect to the rim 201), the processor 120 classifies a current magnetic field strength as weak based on the stored sensor value (operation 731a) and may control a state of the camera module 300 to be a power OFF state (operation 731b). For example, the processor 120 may recognize the state as the folded state and control to cut off power to the camera module 300 in case that a measured value (e.g., a sensor value) transmitted from the sensor 620 is less than 20% of a relative threshold. As a criterion for less than 20% of the relative threshold, a magnetic field strength when a physical distance between the sensor 620 and the magnet 610 is 0 may be set to 100% or X Gauss, and a case of less than 0.2X Gauss corresponding to 20% of X may be regarded as a weak magnetic field and used for state determination.

According to an embodiment, in an intermediate state of the wearable electronic device 101 (or an intermediate state of the temple 204 with respect to the rim 201), a user may be in a state of not wearing the wearable electronic device 101. The intermediate state of the wearable electronic device 101 may be one state operating from the unfolded state to the folded state or operating from the folded state to the unfolded state. In the intermediate state of the wearable electronic device 101, the pole 325 of the camera module 300 may be one of states moving between the rear lateral direction R or the front lateral direction F along the guide slot 415 of the hinge structure 400. In the intermediate state, the camera 310 may be partially exposed to the outside. In the intermediate state, the camera 310 may not be partially exposed to the outside. In the intermediate state, the camera 310 may partially secure a field of view through the opening of the rim 201.

According to an embodiment, in the intermediate state of the wearable electronic device 101 (or the intermediate state of the temple 204 with respect to the rim 201), a distance between the magnet 610 of the camera module 300 and the sensor 620 of the embedded module 500 may be between the folded state and the unfolded state of the wearable electronic device 101. The sensor 620 detects the strength of a magnetic field generated by the magnet 610 and may transmit information (e.g., a sensor value) regarding the magnetic field strength to the wearable electronic device 101 (hereinafter, described as the processor 120).

According to an embodiment, in the intermediate state of the wearable electronic device 101 (or the intermediate state of the temple 204 with respect to the rim 201), the processor 120 may perform an operation of receiving and identifying a sensor value obtained from the sensor 620 (operation 710). For example, the processor 120 may periodically receive a voltage signal from the sensor 620. The voltage signal may be transmitted as an analog value proportional to a magnetic field strength. The signal may be converted to digital data through an analog-to-digital converter. The converted digital value may be stored in an internal register or memory space of the processor 120. The processor 120 may prepare to determine presence or strength of a magnetic field based on the digital value.

According to an embodiment, in the intermediate state of the wearable electronic device 101 (or the intermediate state of the temple 204 with respect to the rim 201), the processor 120 may perform an operation of identifying or determining a current magnetic field strength based on the stored sensor value (operation 720). For example, the processor 120 may classify which range of strong, medium, or weak the magnetic field belongs to by comparing to predefined (or set) thresholds.

According to an embodiment, in the intermediate state of the wearable electronic device 101 (or the intermediate state of the temple 204 with respect to the rim 201), the processor 120 classifies a current magnetic field strength as medium based on the stored sensor value (operation 733a) and may control a state of the camera module 300 to maintain an existing state (operation 733b). For example, in case the existing state is a camera OFF state, the current intermediate state may be maintained as the camera OFF state. For example, in case the existing state is a camera ON state, the current intermediate state may be maintained as the camera ON state. In the camera ON state, the camera 310 may operate in a real-time capturing state (e.g., a black box mode) rather than a camera capturing standby state.

According to an embodiment, in the intermediate state of the wearable electronic device 101 (or the intermediate state of the temple 204 with respect to the rim 201), the processor 120 may recognize the state as the intermediate state and control to maintain power to the camera module 300 the same as the existing state in case a measured value (e.g., a sensor value) transmitted from the sensor 620 is 20% or more and less than 80% of a relative threshold. As a criterion for 20% or more and less than 80% of the relative threshold, a magnetic field strength when a physical distance between the sensor 620 and the magnet 610 is 0 may be set to 100% or X Gauss, and a case of 0.2X Gauss or more and less than 0.8X Gauss corresponding to 20% or more and less than 80% of X may be regarded as a medium magnetic field and used for state determination.

According to an embodiment, in the unfolded state of the wearable electronic device 101 (or the unfolded state of the temple 204 with respect to the rim 201), a user may be in a state of wearing the wearable electronic device 101. In the unfolded state of the wearable electronic device 101, the pole 325 of the camera module 300 may be in a state of being moved in the front lateral direction F along the guide slot 415 of the hinge structure 400. The movement of the pole 325 of the camera module 300 in the front lateral direction F moves the camera module 300 entirely in the front lateral direction F and may cause a portion (e.g., a lens) of the camera 310 to be exposed to the outside. For example, the camera 310 may be in a state in which a portion (e.g., a lens portion) of the camera 310 is exposed to the outside of the rim 201 to maintain a viewing angle easy for capturing.

According to an embodiment, in the unfolded state of the wearable electronic device 101 (or the unfolded state of the temple 204 with respect to the rim 201), a distance between the magnet 610 of the camera module 300 and the sensor 620 of the embedded module 500 may have a relatively close gap D2 compared to other states (e.g., an intermediate state, D1 of a folded state) of the wearable electronic device 101. The sensor 620 detects the strength of a magnetic field generated by the magnet 610 and may transmit information (e.g., a sensor value) regarding the magnetic field strength to the wearable electronic device 101 (hereinafter, described as the processor 120).

According to an embodiment, in the unfolded state of the wearable electronic device 101 (or the unfolded state of the temple 204 with respect to the rim 201), the processor 120 may perform an operation of receiving and identifying and/or determining a sensor value obtained from the sensor 620 (operation 710). For example, the processor 120 may periodically receive a voltage signal from the sensor 620. The voltage signal may be transmitted as an analog value proportional to a magnetic field strength. The signal may be converted to digital data through an analog-to-digital converter. The converted digital value may be stored in an internal register (e.g., storage) or memory space of the processor 120. The processor 120 may prepare to determine presence or strength of a magnetic field based on the digital value.

According to an embodiment, in the unfolded state of the wearable electronic device 101 (or the unfolded state of the temple 204 with respect to the rim 201), the processor 120 may perform an operation of identifying a current magnetic field strength based on the stored sensor value (operation 720). For example, the processor 120 may classify which range of strong, medium, or weak the magnetic field belongs to by comparing to predefined (or set) thresholds.

According to an embodiment, in the unfolded state of the wearable electronic device 101 (or the unfolded state of the temple 204 with respect to the rim 201), the processor 120 classifies a current magnetic field strength as strong based on the stored sensor value (operation 735a) and may control a state of the camera module 300 to be a power ON state and a camera capturing standby state (operation 735b). For example, the processor 120 may recognize the state as the unfolded state and control to activate power to the camera module 300 and control the camera to be in a state capable of capturing images in case a measured value (e.g., a sensor value) transmitted from the sensor 620 is 80% or more of a relative threshold. As a criterion for 80% or more of the relative threshold, a magnetic field strength when a physical distance between the sensor 620 and the magnet 610 is 0 may be set to 100% or X Gauss, and a case of 0.8X Gauss or more corresponding to 80% of X may be regarded as a strong magnetic field and used for state determination.

According to an embodiment, the wearable electronic device 101 may return to a first step (e.g., operation 710) of the operation while identifying in real time whether the temple 204 with respect to the rim 201 is stably maintained (operation 750) and, when not maintained. For example, the processor 120 may identify whether the temple 204 with respect to the rim 201 is stable based on whether a magnetic field strength is stably maintained based on the transmitted sensor value.

FIG. 16 is a view illustrating a state in which a camera module is covered in a folded state of a wearable electronic device according to an embodiment of the disclosure.

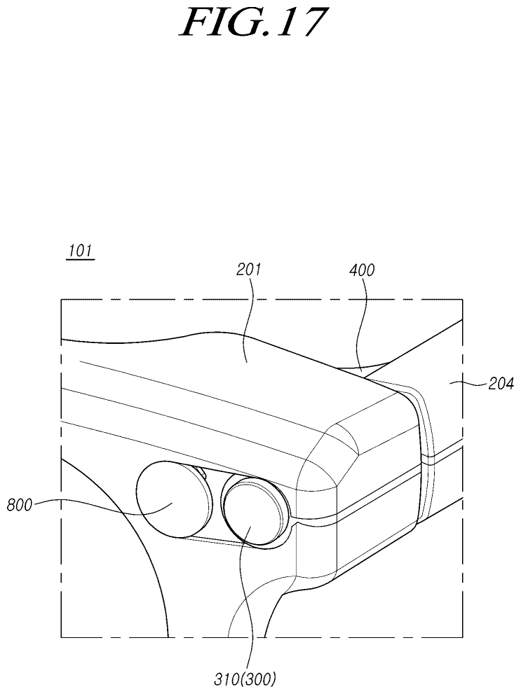

FIG. 17 is a view illustrating a state in which a camera module is uncovered in an unfolded state of a wearable electronic device according to an embodiment of the disclosure.

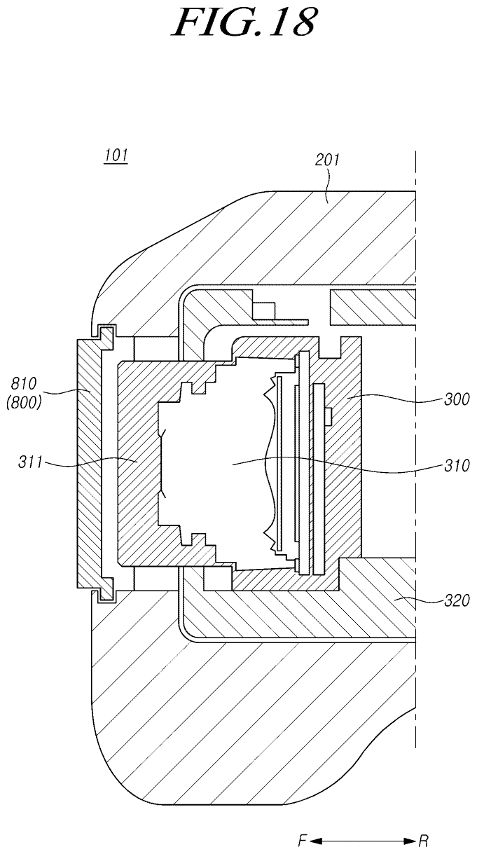

FIG. 18 is a perspective view illustrating an arrangement relationship between a camera and a cover in a folded state of a wearable electronic device according to an embodiment of the disclosure.

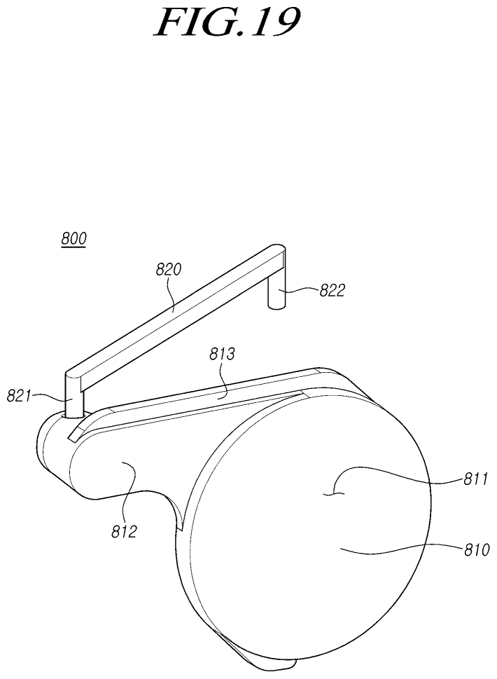

FIG. 19 is a cross-sectional view illustrating an arrangement relationship between a camera and a cover in a folded state of a wearable electronic device according to an embodiment of the disclosure.

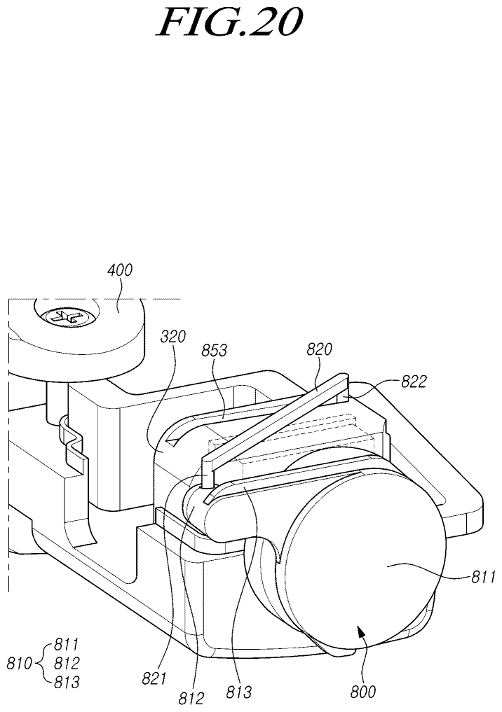

FIG. 20 is a perspective view illustrating a cover structure of a camera module according to an embodiment of the disclosure.

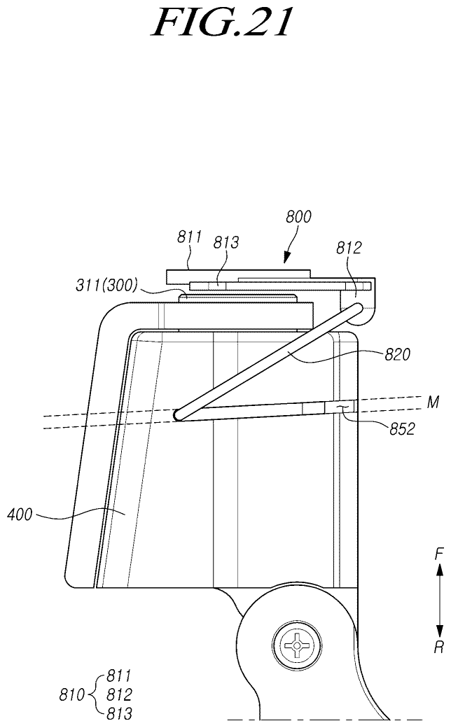

FIG. 21 is a view for illustrating a relationship between a camera and a cover structure in a folded state of a wearable electronic device according to an embodiment of the disclosure.

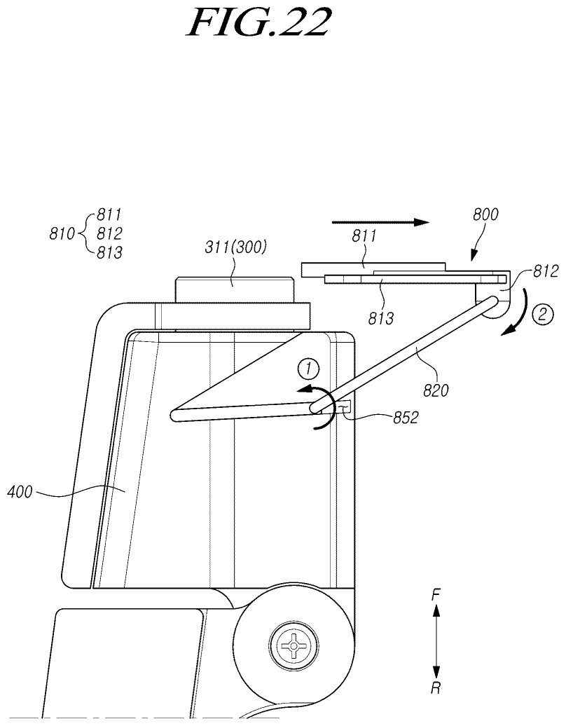

FIG. 22 is a view for illustrating a relationship between a camera and a cover structure in an unfolded state of a wearable electronic device according to an embodiment of the disclosure.

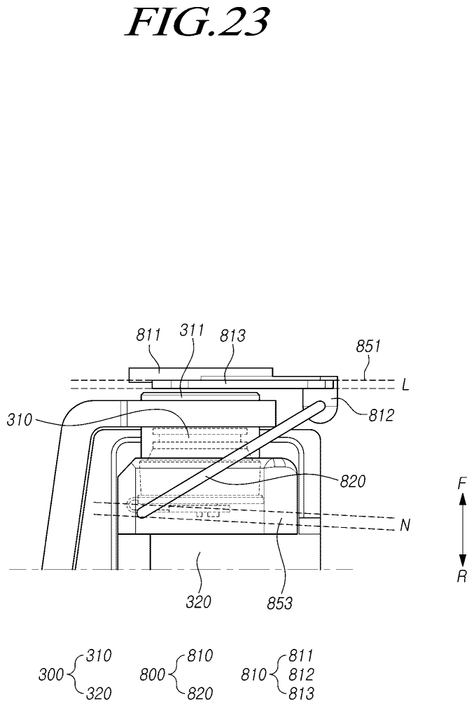

FIG. 23 is a projection view illustrating a movement slot of a rim and a cover structure in a folded state of a wearable electronic device according to an embodiment of the disclosure.

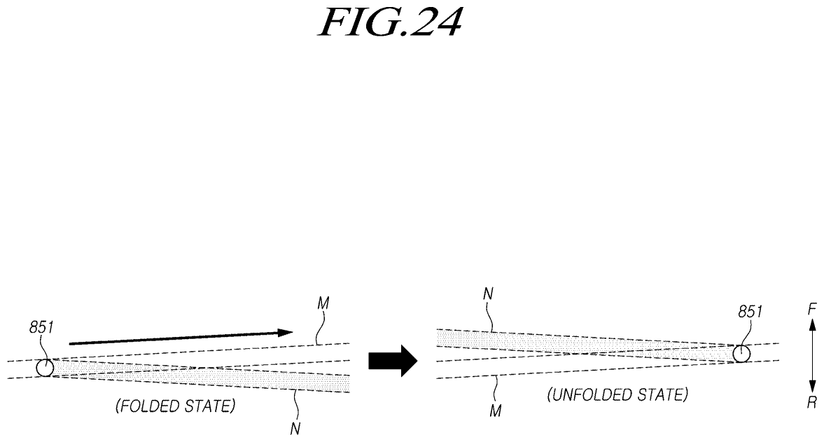

FIG. 24 is a view illustrating a pole moving through movement slots in case of operating from a folded state to an unfolded state of a wearable electronic device according to an embodiment of the disclosure.

According to an embodiment, a wearable electronic device 101 may include a frame 200, a display (e.g., the display 250 of FIG. 4), a camera module 300, and/or a hinge structure 400. The frame 200 may include a rim 201 (e.g., the first rim 201a of FIG. 4, the second rim 201b), a bridge 203 disposed between the first rim 201a and the second rim 201b, and a temple 204 (e.g., the first temple 204a of FIG. 4, the second temple 204b). The hinge structure 400 may connect the temple 204 to the rim 201 to be rotatable. The camera module 300 may move in the front lateral direction F or the rear lateral direction R within the rim 201 and/or the hinge structure 400.

The configurations of the rim 201, the temple 204, the camera module 300, and the hinge structure 400 of FIGS. 16 to 24 may be identical or similar to the configurations of the rim 201, the temple 204, the camera module 300, and the hinge structure 400 of FIGS. 2 to 7.

The embodiments of FIGS. 16 to 24 may be selectively combined with the embodiments of FIGS. 1 to 15.

According to an embodiment, the camera module 300 may include a camera 310, a camera bracket 320, and a cover structure 800. The camera bracket 320 may include a first portion 321 providing a space for receiving the camera 310, a second portion 322 having a pole 325 guiding movement of the camera bracket 320, and a bridge portion 323 connecting the first portion 321 and the second portion 322. The cover structure 800 is a structure for covering a lens portion 311 of the camera 310 and may include a cover 810 configured to cover a front of the lens portion 311, and a link 820 providing movement of the cover 810.

According to an embodiment (e.g., see FIG. 16), in the folded state of the wearable electronic device 101 (or the folded state of the temple 204 with respect to the rim 201), the cover structure 800 of the camera module 300 may cover the camera 310 so as not to be visible from the outside. For example, during the folding operation of the wearable electronic device 101, the camera module 300 is moved in the rear lateral direction R and may withdraw into the rim 201 (or the hinge structure 400) so as not to be exposed to the outside. If the cover structure 800 is excluded, a front portion of the camera module 300 (e.g., the lens portion 311 of the camera 310) may be visible from the outside due to the opening of the rim 201. According to an embodiment, the cover structure 800 may block (e.g., reduce or prevent) contact with external foreign objects or impact by being disposed to cover the front of the camera module 300 (e.g., the lens portion 311 of the camera 310) in the folded state of the wearable electronic device 101.

According to an embodiment (e.g., see FIG. 17), in the unfolded state of the wearable electronic device 101 (or the unfolded state of the temple 204 with respect to the rim 201), the cover structure 800 of the camera module 300 may be in a state of being moved so that the camera 310 is visible from the outside. For example, during the unfolding operation of the wearable electronic device 101, the camera module 300 moves in the front lateral direction F and a portion may protrude to be exposed to the outside of the rim 201. In this case, the cover structure 800 may move in an outward direction (e.g., left and right directions) of the exposed camera module 300 so that the camera 310 (or the camera bracket 320) and the cover structure 800 do not collide with or cover each other.

According to an embodiment, in the folded state of the wearable electronic device 101 (or the folded state of the temple 204 with respect to the rim 201), the cover 810 of the cover structure 800 may be spaced apart from the camera 310 so as not to contact the camera 310. For example, the cover 810 may be disposed in parallel with the lens portion 311 of the camera 310.

According to an embodiment, the cover 810 of the cover structure 800 may move to the lens portion 311 or other portions (e.g., a front side portion of the rim 201) by the link 820. The cover 810 may include a circular portion 811 corresponding to the lens portion 311 and a connection portion 812 extending from the circular portion 811 and coupled to the link 820. The link 820 is a structure for connecting the hinge bracket 410 (or the camera bracket 320) and the cover 810, and one side is rotatably connected to the connection portion 812 of the cover 810, and the other side may be rotatably connected to the hinge bracket 410 (or the camera bracket 320). For example, the link 820 has a ‘ [symbol] ’ shape, and each of poles (e.g., a first pole 821, a second pole 822) extending in a downward direction may be rotatably coupled to grooves formed in the cover 810 and the hinge bracket 410 (or the camera bracket 320). For example, the second pole 822 formed on the other side may pass through an opening of the hinge bracket 410 and be connected to a groove (e.g., a third guide slot 853) of the camera bracket 320.

According to an embodiment, guide slots (e.g., a first guide slot 851, a second guide slot 852, a third guide slot 853) may be formed in the rim 201, the hinge bracket 410, and/or the camera bracket 320 for movement of the cover structure 800 in response to an unfolding/folding operation of the wearable electronic device 101.

According to an embodiment, a first guide slot (e.g., a virtual line L having a slot formed therein disclosed in FIG. 23 is referred to as the first guide slot 851) in parallel with the lens portion 311 may be formed in the rim 201 to guide movement of the cover structure 800. For example, a protrusion 813 protruding from an upper side or a lower side of the cover structure 800 may move to a left side or a right side in a state of being inserted into the first guide slot 851.

According to an embodiment, a second guide slot 852 extending to be inclined with respect to the lens portion 311 (or the first guide slot 851) may be formed in the hinge bracket 410 to guide movement of the cover structure 800. For example, the second pole 822 of the cover structure 800 may rotate and move in a state of being inserted into the second guide slot 852.

According to an embodiment, a third guide slot 853 extending to be inclined with respect to the lens portion 311 (or the first guide slot 851) may be formed in the camera bracket 320 to guide movement of the cover structure 800. The inclined direction of the third guide slot 853 may be opposite to the inclined direction of the second guide slot 852. For example, the third guide slot 853 and the second guide slot 852 may be formed to cross each other. For example, the second guide slot 852 may be formed on the upper side of the third guide slot 853 so that at least a portion overlaps. For example, the second pole 822 of the cover structure 800 may pass through the second guide slot 852 and then rotate and move in a state of being inserted into the third guide slot 853.

Hereinafter, referring to FIGS. 21 to 24, movement of the cover structure 800 in response to an unfolding operation of the wearable electronic device 101 (e.g., from the folded state to the unfolded state) is described. A virtual line M in FIG. 24 represents a direction in which the second guide slot 852 moves, and a virtual line N represents a direction in which the third guide slot 853 moves. In FIG. 24, the virtual line M is in a fixed state, and the virtual line N may move in the front lateral direction F by the unfolding operation of the wearable electronic device 101. The second pole 822 of the link 820 inserted into the second guide slot 852 and the third guide slot 853 may move along the second guide slot 852 and the third guide slot 853.

According to an embodiment, in the folded state of the wearable electronic device 101 (or the folded state of the temple 204 with respect to the rim 201), the lens portion 311 of the camera 310 of the camera module 300 may be in a state of being covered by the cover structure 800. The first pole 821 of the link 820 is in a state of being connected to the cover 810, and the second pole 822 may pass through the hinge bracket 410 and be connected to the camera bracket 320. The first pole 821 of the link 820 may be located on the right side of the lens portion 311 disclosed in FIG. 21, and the second pole 822 may be located on the left side of the lens portion 311 and on the left side of the second and third guide slots 852, 853.

According to an embodiment, during the unfolding operation of the wearable electronic device 101 (or in the intermediate state), the second pole 822 of the link 820 may move from a left side to a right side along the second guide slot 852 and the third guide slot 853. For example, the second pole 822 of the link 820 may move to the right side along the second guide slot 852 of the fixed hinge bracket 410. For example, the second pole 822 of the link 820 may move to the right side along the third guide slot 853 of the camera bracket 320 moving in the front lateral direction F. For example, referring to FIG. 24, the second pole 822 of the link 820 rotates and moves to the right side along the second guide slot 852 and the third guide slot 853, and as only the third guide slot 853 moves in the front lateral direction F, an intersection point of the second guide slot 852 and the third guide slot 853 may be formed at some movement points.

According to an embodiment, during the unfolding operation of the wearable electronic device 101 (or in the intermediate state), movement of the second pole 822 of the link 820 also moves the first pole 821 together to the right side, and the cover 810 connected to the first pole 821 may also move to the right side so as not to cover the lens portion 311 of the camera 310. The lens portion 311 of the camera 310 is exposed while moving in the front lateral direction F, and the cover 810 moves to the right side so that a wide viewing angle of the lens portion 311 may be utilized. The first pole 821 may perform a rotational movement in a second direction \textcircled{2} about a groove of the connection portion 812 as a central axis together with the rightward movement, and the second pole 822 linked thereto may perform a rotational movement in a first direction \textcircled{1} opposite to the second direction \textcircled{2} together with the rightward movement along the second and third guide slots 852, 853.

According to an embodiment, in the unfolded state of the wearable electronic device 101 (or the unfolded state of the temple 204 with respect to the rim 201), the lens portion 311 of the camera 310 of the camera module 300 may be in a state of not being covered by the cover structure 800. The first pole 821 of the link 820 may be located on the right side of the lens portion 311, and the second pole 822 may be located on the right side of the lens portion 311 and on the right side of the second and third guide slots 852, 853.

According to an embodiment, the cover structure 800 of the wearable electronic device 101 may be designed to be physically linked to movement of the camera bracket 320 (or the camera 310) in the front lateral direction or the rear lateral direction F, R to move to the left side or the right side, thereby safely protecting the lens portion 311 of the camera 310 in a simple and convenient manner.

A wearable electronic device (e.g., smart glasses) may include a camera module to capture images (or videos) or for an artificial intelligence function. The camera module has a camera lens disposed to protrude to the outside of smart glasses to provide a wide viewing angle. In this case, there is a concern that the lens may be damaged or broken due to external contaminants, and thus enhancement is required.

A wearable electronic device (e.g., smart glasses) according to an embodiment of the disclosure may provide a structure in which a position of a camera module is linked in a front lateral direction or a rear lateral direction according to unfolding or folding of a temple with respect to a rim.

A camera module of a wearable electronic device (e.g., smart glasses) according to an embodiment of the disclosure may provide a wide viewing angle by protruding a portion of the camera in the unfolded state, and may safely protect the camera by withdrawing the camera into an electronic device in the folded state.

A wearable electronic device (e.g., smart glasses) according to an embodiment of the disclosure may allow a pole formed in a camera module to slide along a guide slot formed in a hinge structure. The movement of the pole may provide a simple structure that structurally moves the camera to the front or rear side.

In a wearable electronic device (e.g., smart glasses) according to an embodiment of the disclosure, movement of the camera module to the front or rear side may vary a distance between a sensor and a magnet inside the electronic device. The electronic device may easily switch an operation of the camera (e.g., power ON or power OFF) in response to a distance between the sensor and the magnet.

A wearable electronic device (e.g., smart glasses) according to an embodiment of the disclosure may provide a cover structure that structurally exposes or covers a camera lens in case that the camera module moves to the front or rear side. Accordingly, the camera may be stably protected from an external environment.

The effects obtainable from the disclosure are not limited to the effects mentioned above, and other effects not mentioned are clearly understood by those of ordinary skill in the art to which the disclosure belongs from the following description.

A wearable electronic device 101 according to an embodiment of the disclosure may include a rim 201 having an opening formed toward a front side, a temple 204 disposed on one side of the rim, a hinge structure 400 rotatably connecting the temple to the rim, and a camera module 300 disposed at least partially movable within the rim or the hinge structure. The camera module 300 may include a camera 310 and a camera bracket 320 including a space for receiving the camera and a pole 325 connected to the hinge structure. The hinge structure 400 may include a guide slot 415 forming a movement path of the pole with a portion of the pole inserted therein.

According to an embodiment, when the temple rotates with respect to the rim, the pole 325 of the camera bracket may move along the guide slot 415, and the camera received in the camera bracket may be configured to move toward the front side F or a rear side R.

According to an embodiment, when the temple rotates from a folded state to an unfolded state with respect to the rim, the pole 325 of the camera bracket 320 may move from a first position P1 to a second position P2 of the guide slot 415, and the camera bracket 320 may be configured to move toward the front side to expose a portion of the camera to the outside.

According to an embodiment, when the temple rotates from the unfolded state to a folded state with respect to the rim, the pole 325 of the camera bracket 320 may move from the second position P2 to the first position P1 of the guide slot 415, and the camera bracket 320 may be configured to move toward the rear side to receive the camera inside the rim.

According to an embodiment, the wearable electronic device 101 may further include an embedded module 500 disposed adjacent to the camera module within the hinge structure 400 and configured to receive a plurality of components. The embedded module may be located between the camera 310 and the pole 325.

According to an embodiment, the camera module 300 may be configured to move to the front side or the rear side with respect to the embedded module 500.

According to an embodiment, the embedded module may include a hook structure 501 configured to allow the temple to be detachably coupled to the rim. The hook structure 501 may include a hook bracket 520, a hook 510 disposed within the hook bracket 520, protruding toward the rim 201, and having an inclined side (e.g., surface) formed on a protruding portion thereof, and a hook elastic member 530 disposed within the hook bracket 520, connected to one side of the hook 510, and configured to provide a tension for fastening the rim 201 and the temple 204 via the hook 510.

According to an embodiment, the guide slot 415 may have a width corresponding to the diameter of the pole 325 and may be formed in a curved recess shape.

According to an embodiment, the guide slot 415 may extend to partially surround a hinge axis of the hinge structure 400 and may have a curvature value that varies along a length direction.

According to an embodiment, a central axis of the guide slot 415 and a hinge axis of the hinge structure 400 may be disposed not to be aligned.

According to an embodiment, during an unfolding operation of the temple with respect to the rim, the pole 325 of the camera bracket 320 may be configured to move toward the front side along a curved recess of the guide slot 415.

According to an embodiment, during a folding operation of the temple with respect to the rim, the pole 325 of the camera bracket 320 may be configured to move toward the rear side along a curved recess of the guide slot 415.

According to an embodiment, in the folded state of the temple with respect to the rim, a first distance L1 may be defined between the first position P1 of the pole 325 of the camera bracket 320 and a hinge axis of the hinge structure 400.

According to an embodiment, in the unfolded state of the temple with respect to the rim, a second distance L2 greater than the first distance L1 may be defined between the second position P2 of the pole 325 of the camera bracket 320 and the hinge axis of the hinge structure 400.

According to an embodiment, the wearable electronic device 101 may further include a sensor 620 and a magnet 610 disposed facing the sensor. When the temple rotates with respect to the rim, a separation distance between the sensor 620 and the magnet 610 may be configured to vary.

According to an embodiment, the sensor 620 may be disposed on one side of the camera module 300, and the magnet 610 may be disposed on an embedded module 500 fixed within the hinge structure.

According to an embodiment, in the folded state of the temple with respect to the rim, a first gap D1 may be present between the sensor and the magnet, and in the unfolded state of the temple with respect to the rim, a second gap D2 smaller than the first gap D1 may be present between the sensor and the magnet.

According to an embodiment, the wearable electronic device 101 may include a memory storing one or more instructions and at least one processor including processing circuitry. The one or more instructions may, when executed by the at least one processor individually or collectively, cause the wearable electronic device to perform an operation of receiving and identifying sensor values obtained from the sensor, an operation of identifying a strength of a magnetic field in a current state based on the received sensor values, and cause to control an operation of the camera module 300 by classifying and determining the magnetic field strength as strong, medium, or weak.

According to an embodiment, in the unfolded state of the temple with respect to the rim, the one or more instructions may, when executed by the at least one processor individually or collectively, cause the wearable electronic device to determine that a strength of the magnetic field is strong and activate power to the camera module to cause the camera to be controlled to be in a state capable of capturing images.

According to an embodiment, in the folded state of the temple with respect to the rim, the instructions may, when executed by the at least one processor individually or collectively, cause the wearable electronic device to determine that a strength of the magnetic field is weak and deactivate power to the camera module to cause the camera to be controlled to be in a state incapable of capturing images.

According to an embodiment, the wearable electronic device (101) may further comprise a cover which is movable between a first position at which the cover blocks the camera when the camera moves to the rear side and a second position at which the cover uncovers the camera when the camera moves to the front side.

A wearable electronic device 101 according to an embodiment of the disclosure may include a rim 201 having an opening formed toward a front side, a temple 204 disposed on one side of the rim, a hinge structure 400 rotatably connecting the temple to the rim, a camera module 300 disposed at least partially movable within the rim or the hinge structure, at least one processor 120 including processing circuitry, and a memory 130 storing one or more instructions. The instructions may, when executed by the at least one processor individually or collectively, cause the wearable electronic device to, in the unfolded state of the temple with respect to the rim, when a portion of the camera module 300 is exposed to the outside, activate power to the camera module to control the camera module to be in a state capable of capturing images, and in the folded state of the temple with respect to the rim, when the camera module 300 is received inside the rim, deactivate power to the camera module to control the camera module to be in a state incapable of capturing images.

According to an embodiment, the camera module may include a camera and a camera bracket including a space for receiving the camera and a pole connected to the hinge structure. The hinge structure may include a guide slot forming a movement path of the pole. When the temple rotates with respect to the rim, the pole of the camera bracket may move along the guide slot, and the camera received in the camera bracket may be configured to move toward the front side or a rear side.

According to an embodiment, during an unfolding operation of the temple with respect to the rim, the pole 325 of the camera bracket 320 may move from a first position P1 to a second position P2 along the guide slot 415, and the camera bracket 320 may be configured to move toward the front side to expose a portion of the camera to the outside.

According to an embodiment, during a folding operation of the temple with respect to the rim, the pole 325 of the camera bracket 320 may move from the second position P2 to the first position P1 along the guide slot 415, and the camera bracket 320 may be configured to move toward the rear side to receive the camera inside the rim.

According to an embodiment, the guide slot 415 may have a width corresponding to the diameter of the pole 325 and may be formed in a curved recess shape.

A method of operating a camera of a wearable electronic device according to an embodiment of the disclosure may include assuming a folded state unsuitable for being worn by a user, an unfolded state suitable for being worn by the user and an intermediate state between the folded and unfolded states, the method may comprise: identifying a magnetic field strength from a sensor value; powering the camera in an event the magnetic field strength is identified as being strong in a case in which the wearable electronic device assumes the unfolded state; unpowering the camera in an event the magnetic field strength is identified as being weak in a case in which the wearable electronic device assumes the folded state; and maintaining a camera power state in an event the magnetic field strength is identified as being medium in a case in which the wearable electronic device assumes the intermediate state.

1. A wearable electronic device, comprising:
a rim having an opening formed toward a front side;
a temple disposed on one side of the rim;
a hinge structure configured to rotatably connect the temple to the rim; and
a camera module disposed to be at least partially movable within the rim or the hinge structure,
wherein the camera module comprises a camera, and a camera bracket including a space for accommodating the camera and a pole connected to the hinge structure,
wherein the hinge structure comprises a guide slot forming a movement path of the pole with a portion of the pole inserted therein, and
wherein, when the temple rotates with respect to the rim, the pole of the camera bracket moves along the guide slot, and the camera accommodated in the camera bracket is configured to move toward the front side or a rear side.

2. The wearable electronic device of claim 1,
wherein:
when the temple rotates from a folded state to an unfolded state with respect to the rim, the pole of the camera bracket moves from a first position of the guide slot to a second position of the guide slot, and the camera bracket is configured to move toward the front side to expose at least a portion of the camera to the outside.

3. The wearable electronic device of claim 2,
wherein, when the temple rotates from the unfolded state to a folded state with respect to the rim, the pole of the camera bracket moves from the second position to the first position of the guide slot, and the camera bracket is configured to move toward the rear side to accommodate the camera inside the rim.

4. The wearable electronic device of claim 1, further comprising:
an embedded module disposed adjacent to the camera module within the hinge structure and configured to accommodate a plurality of components, and
wherein the embedded module is located between the camera and the pole.

5. The wearable electronic device of claim 4,
wherein the camera module is configured to move to the front side or the rear side with respect to the embedded module.

6. The wearable electronic device of claim 4,
wherein the embedded module includes a hook structure configured to allow the temple to be detachably coupled to the rim,
wherein the hook structure comprises:
a hook bracket;
a hook disposed within the hook bracket, protruding toward the rim, and having an inclined surface on a protruding portion thereof; and
a hook elastic member disposed within the hook bracket, being connected to one side of the hook, and configured to provide a tension for fastening the rim and the temple via the hook.

7. The wearable electronic device of claim 1,
wherein the guide slot has a width corresponding to a diameter of the pole and is formed in a curved recess shape.

8. The wearable electronic device of claim 1,
wherein the guide slot extends to partially surround a hinge axis of the hinge structure and has a curvature value that varies along a longitudinal direction thereof.

9. The wearable electronic device of claim 1,
wherein a central axis of the guide slot and a hinge axis of the hinge structure are arranged not to be aligned.

10. The wearable electronic device of claim 1,
wherein, during an unfolding operation of the temple with respect to the rim, the pole of the camera bracket is configured to move toward the front side along a curved recess of the guide slot, and
wherein, during a folding operation of the temple with respect to the rim, the pole of the camera bracket is configured to move toward the rear side along the curved recess of the guide slot.

11. The wearable electronic device of claim 1,
wherein, in the folded state of the temple with respect to the rim, a first distance is defined between a first position of the pole of the camera bracket and a hinge axis of the hinge structure, and
wherein, in the unfolded state of the temple with respect to the rim, a second distance, which is greater than the first distance, is defined between a second position of the pole of the camera bracket and the hinge axis of the hinge structure.

12. The wearable electronic device of claim 1, further comprising:
a sensor; and
a magnet disposed facing the sensor,
wherein, when the temple rotates with respect to the rim, a separation distance between the sensor and the magnet is configured to vary.

13. The wearable electronic device of claim 12,
wherein the sensor is disposed on one side of the camera module, and the magnet is disposed on an embedded module fixed within the hinge structure, and
wherein, in the folded state of the temple with respect to the rim, the sensor has a first gap from the magnet, and
wherein, in the unfolded state of the temple with respect to the rim, the sensor has a second gap, which is smaller than the first gap, from the magnet.

14. The wearable electronic device of claim 12, further comprising:
a memory storing one or more instructions; and
at least one processor including processing circuitry,
wherein the one or more instructions, when executed by the at least one processor individually or collectively, are configured to cause the wearable electronic device to:
receive and identify sensor values obtained from the sensor;
identify a strength of a magnetic field in a current state based on the received sensor values; and
classify and determine the magnetic field strength as strong, medium, or weak, and control an operation of the camera module accordingly.

15. The wearable electronic device of claim 14,
wherein, in the unfolded state of the temple with respect to the rim, the one or more instructions, when executed by the at least one processor individually or collectively, are configured to cause the wearable electronic device to:
determine that the strength of the magnetic field is strong, and activate power to the camera module, thereby controlling the camera to be in a state capable of capturing images.

16. The wearable electronic device of claims 15,
wherein, in the folded state of the temple with respect to the rim, the one or more instructions, when executed by the at least one processor individually or collectively, are configured to cause the wearable electronic device to:
determine that the magnetic field strength is weak, and deactivate power to the camera module, thereby controlling the camera to be in a state incapable of capturing images.

17. A wearable electronic device, comprising:
a rim having an opening formed toward a front side;
a temple disposed on one side of the rim;
a hinge structure configured to rotatably connect the temple to the rim;
a camera module disposed to be at least partially movable within the rim or the hinge structure;
at least one processor including processing circuitry; and
a memory storing one or more instructions, wherein the one or more instructions, when executed by the at least one processor individually or collectively, are configured to cause the wearable electronic device to:
in an unfolded state of the temple with respect to the rim, when a portion of the camera module is exposed to the outside, activate power to the camera module to control the camera module to be in a state capable of capturing images, and
in a folded state of the temple with respect to the rim, when the camera module is received inside the rim, deactivate power to the camera module to control the camera module to be in a state incapable of capturing images.

18. The wearable electronic device of claim 17,
wherein the camera module includes a camera, and a camera bracket including a space for receiving the camera and a pole connected to the hinge structure,
wherein the hinge structure includes a guide slot forming a movement path of the pole, and
wherein, when the temple rotates with respect to the rim, the pole of the camera bracket moves along the guide slot, and the camera received in the camera bracket is configured to move toward the front side or a rear side.

19. The wearable electronic device of claim 18,
wherein, during an unfolding operation of the temple with respect to the rim, the pole of the camera bracket moves from a first position to a second position along the guide slot, and the camera bracket is configured to move toward the front side to expose at least a portion of the camera to the outside.

20. The wearable electronic device of claim 19,
wherein, during a folding operation of the temple with respect to the rim, the pole of the camera bracket moves from the second position to the first position along the guide slot, and the camera bracket is configured to move toward the rear side to receive the camera inside the rim.
